(19) United States
(12) Patent Application Publication
(10) Pub. No.: US 2018/0217809 A1
(43) Pub. Date: Aug. 2, 2018

(54) EARPHONES, MOBILE TERMINAL CONNECTABLE THERETO, AND CONTROL METHOD

(71) Applicant: LG ELECTRONICS INC., Seoul (KR)

(72) Inventors: Hyunseung YU, Seoul (KR); Junhan PARK, Seoul (KR); Chunggu KANG, Seoul (KR); Heejeong SEO, Seoul (KR)

(73) Assignee: LG Electronics Inc., Seoul (KR)

(21) Appl. No.: 15/748,218

(22) PCT Filed: Mar. 3, 2016
(86) PCT No.: PCT/KR2016/002149

§ 371 Date: Jan. 29, 2018

(30) Foreign Application Priority Data
Aug. 7, 2015 (KR) 10-2015-0111443

(51) Int. Cl. G06F 3/16; H01R 24/58; H04R 1/10; H04R 5/04

(52) U.S. Cl. CPC G06F 3/165; H01R 24/58; H04R 2420/07; H04R 5/04; G06F 3/167; H04R 1/1041

(57) ABSTRACT

An earphone, a mobile terminal capable of being connected with the earphone, and a control method thereof are disclosed, in which the mobile terminal may be used considering user convenience. The earphone comprises an earphone jack; a first microphone unit; a first speaker unit and a second speaker unit; a noise cancellation unit for cancelling a noise component in the periphery of the earphone; and an interface unit for delivering a power source supplied from a mobile terminal to the noise cancellation unit, wherein the interface unit changes its connection switch with at least any one of the first speaker unit, the second speaker unit, and the first microphone unit on the basis of a mode of the mobile terminal while the power source is being delivered to the noise cancellation unit through a microphone line of the earphone jack.

### TECHNICAL FIELD

The present invention relates to an earphone, a mobile terminal capable of being connected with the earphone, and a control method thereof, in which the mobile terminal may be used considering user convenience.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

As functions of the mobile terminal become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

In order to support and enhance such functions of the mobile terminal, improvement of a structural portion and/or software portion of the mobile terminal may be considered.

Also, the mobile terminal may provide a user with a sound such as call voice and music through an earphone.

However, when the user listens to a sound through the earphone, there is inconvenience in that the user listens to the sound mixed with noise components due to external noise.

### DISCLOSURE

### Technical Problem

The present invention is intended to solve the aforementioned problem and other problems. An object of the present invention is to provide an earphone that may cancel external noise even without a separate battery.

Another object of the present invention is to provide an earphone capable of performing communication with a mobile terminal.

Still another object of the present invention is to provide an earphone capable of cancelling external noise in accordance with a mode of a mobile terminal.

Further still another object of the present invention is to provide an earphone capable of varying a purpose of use of a microphone in accordance with its attachment or detachment.

Further still another object of the present invention is to provide a mobile terminal capable of supplying a power source in accordance with a type of an earphone.

Further still another object of the present invention is to provide a mobile terminal capable of controlling noise cancellation of an earphone.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

An earphone according to one embodiment of the present invention comprises an earphone jack; a first microphone unit; a first speaker unit and a second speaker unit; a noise cancellation unit for cancelling a noise component in the periphery of the earphone; and an interface unit for delivering a power source supplied from a mobile terminal to the noise cancellation unit, wherein the interface unit changes its connection switch with at least any one of the first speaker unit, the second speaker unit, and the first microphone unit on the basis of a mode of the mobile terminal while the power source is being delivered to the noise cancellation unit through a microphone line of the earphone jack.

A mobile terminal capable of being connected with an earphone according to one embodiment of the present invention comprises an audio processor; an earphone socket; an earphone sensor for sensing a type of the earphone connected to the earphone socket; and an interface unit for delivering a power source to the earphone in accordance with the type of the earphone, wherein the interface unit changes its connection switch with at least any one of the audio processor and the earphone sensor on the basis of an execution mode while the power source is being delivered to the earphone through a microphone line of the earphone socket.

### Advantageous Effects

Advantageous effects of an earphone, a mobile terminal to which the earphone is applied and a control method according to the present invention are as follows.

According to at least one of the embodiments of the present invention, an earphone may be provided, which improves sound quality and has convenient portability by cancelling external noise even without a separate battery.

According to at least one of the embodiments of the present invention, since an earphone is capable of performing communication with a mobile terminal, there may be provided convenience in that the mobile terminal may control the earphone.

According to at least one of the embodiments of the present invention, there may be provided convenience in that a purpose of use of a microphone may be varied in accordance with detachment of an earphone.

According to at least one of the embodiments of the present invention, since a power supply to an earphone is determined in accordance with a type of the earphone, there is compatibility of various types of earphones.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

FIG. 1a is a block diagram illustrating a mobile terminal according to the present invention.

FIGS. 1b and 1c are conceptual views illustrating one example of the mobile terminal, viewed from different directions.

FIG. 2 is a conceptual view illustrating another example of a modifiable mobile terminal according to the present invention.

FIG. 3 is a perspective view illustrating a watch type mobile terminal according to another embodiment of the present invention.

FIG. 4 is a perspective view illustrating a glass type mobile terminal according to still another embodiment of the present invention.

FIG. 5 is a view briefly illustrating an earphone connected to the mobile terminal according to one embodiment of the present invention.

FIG. 6 is a block diagram illustrating component modules of an earphone according to one embodiment of the present invention.

FIG. 7 is a schematic block diagram illustrating a first switching unit of FIG. 6.

FIG. 8 is a schematic block diagram illustrating a second switching unit of FIG. 6.

FIG. 9 is a block diagram illustrating component modules of a mobile terminal according to one embodiment of the present invention.

FIG. 10 is a block diagram illustrating a switching unit of FIG. 9.

FIG. 11 is a view illustrating circuit connection between a mobile terminal and an earphone according to one embodiment of the present invention.

FIG. 12 is a view illustrating an interface unit of an earphone.

FIGS. 13 to 16 are views illustrating circuit connection between a mobile terminal and an earphone according to a mode of a mobile terminal.

FIG. 17 is a view illustrating circuit connection between a mobile terminal and an earphone according to attachment or detachment of the earphone.

FIG. 18 is a view illustrating circuit connection of a mobile terminal according to a type of an earphone.

FIG. 19 is a flow chart illustrating a method for controlling a mobile terminal according to one embodiment of the present invention.

FIG. 20 is a view illustrating a method for identifying a type of an earphone.

FIGS. 21 and 22 are views illustrating a method for setting a noise cancellation of an earphone.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

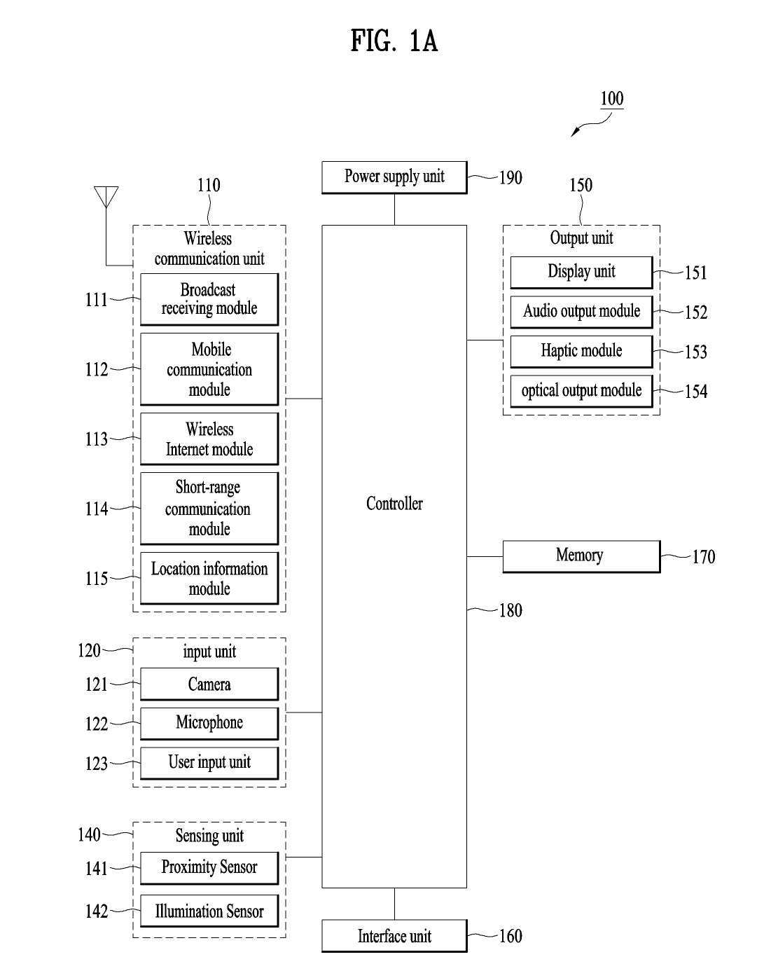

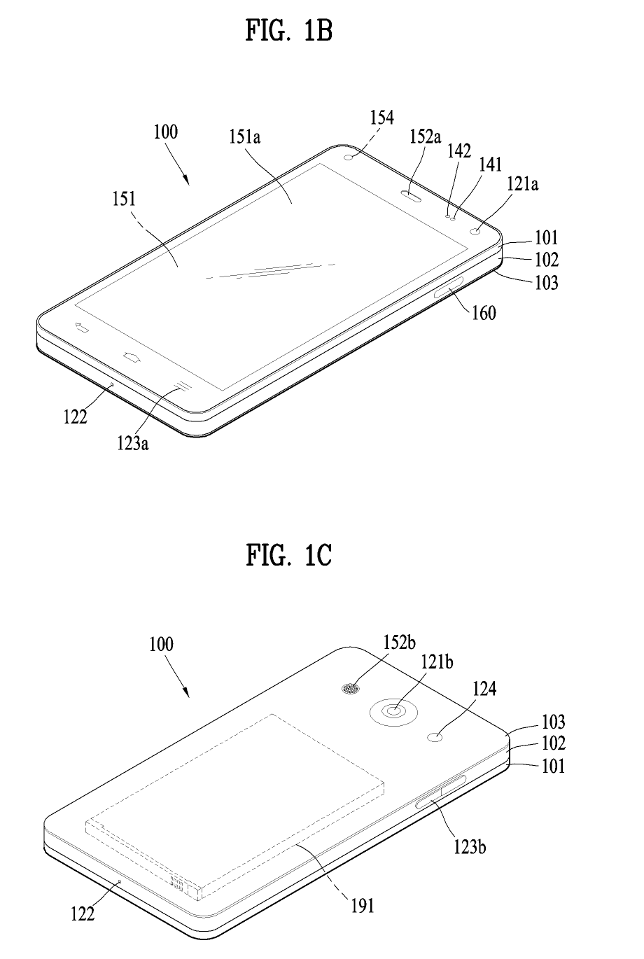

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170.

As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the components mentioned in the foregoing description can operate cooperatively to implement operations, controls or controlling methods of the mobile terminal according to various embodiments mentioned in the following description. Moreover, the operations, controls and controlling methods of the mobile terminal may be implemented on the mobile terminal by running or executing at least one application program saved in the memory 170.

Prior to looking into various embodiments implemented through the mobile terminal 100, the above-mentioned components will now be described in more detail with reference to FIG. 1A as follows.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) , LTE-A(Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

In this case, the terminal body may be appreciated as a concept of regarding the mobile terminal 100 as at least one assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display unit 151, a 1^{st} audio output unit 152a, a 2^{nd} audio output unit 152b, a proximity sensor 141, an illumination sensor 142, an optical output unit 154, a 1^{st} camera 121a, a 2^{nd} camera 121b, a 1^{st} manipulation unit 123a, a 2^{nd} manipulation unit 123b, a microphone 122, an interface unit 160 and the like.

For the following description, as shown in FIG. 1B and FIG. 1C, the mobile terminal 100 having the following dispositions is taken as one example. First of all, the display unit 151, the 1^{st} audio output unit 152a, the proximity sensor 141, the illumination sensor 142, the optical output unit 154, the 1^{st} camera 121a and the 1^{st} manipulation unit 123a are disposed on a front side of the terminal body. Secondly, the 2^{nd} manipulation unit 123b, the microphone 122 and the interface unit 160 are disposed on a lateral side of the terminal body. Thirdly, the 2^{nd} audio output unit 152b and the 2^{nd} camera 121b are disposed on a rear side of the terminal body.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Also, in the present invention, information processed from the mobile terminal can be displayed by using a flexible display.

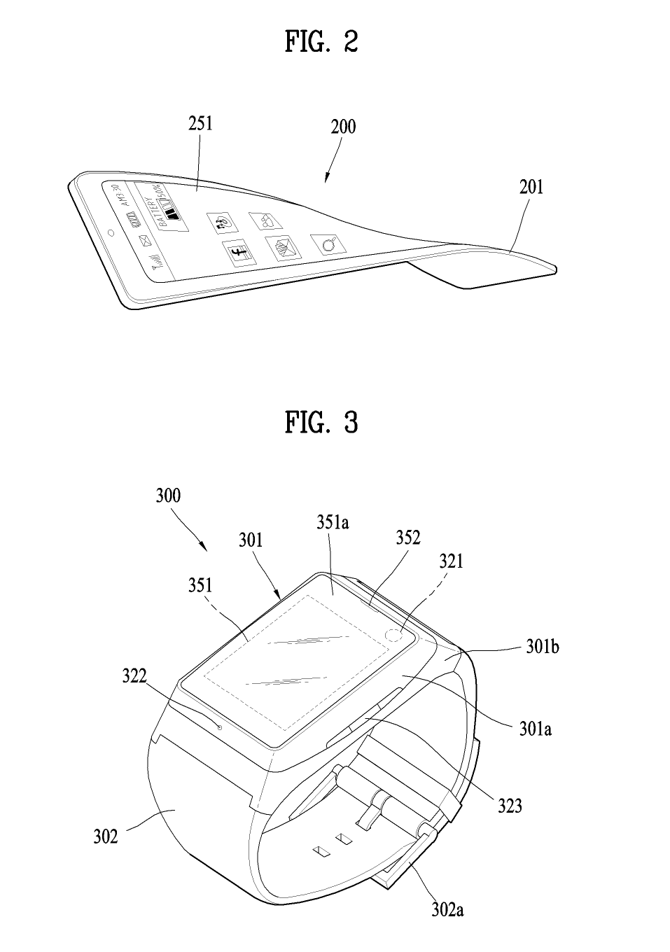

FIG. 2 is a conceptual view of a deformable mobile terminal according to an alternative embodiment of the present invention.

In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state(or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

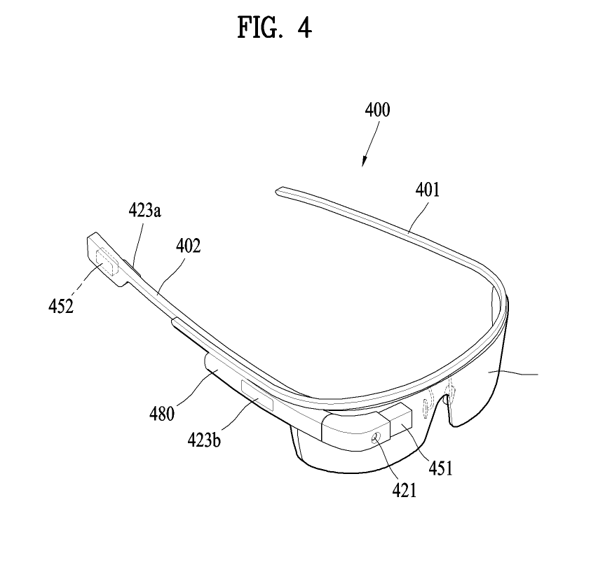

FIG. 3 is a perspective view illustrating one example of a watch-type mobile terminal 300 in accordance with another exemplary embodiment.

As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

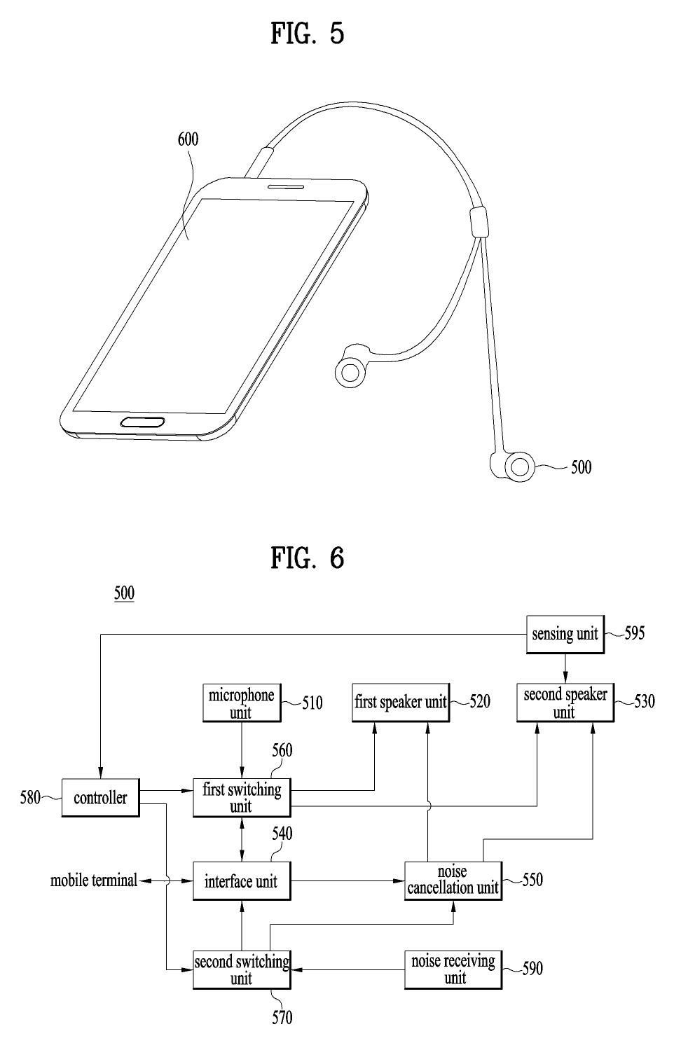

FIG. 4 is a perspective view illustrating one example of a glass-type mobile terminal 400 according to another exemplary embodiment.

The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing.

The camera 421 may be positioned at most any location of the mobile terminal. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

A communication system which is operable with the variously described mobile terminals will now be described in more detail.

Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system.

A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal.

Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

Also, the case that the mobile terminal in the embodiments of the present invention is the mobile terminal 100 of FIGS. 1A to 1C is described as an example. However, the mobile terminal may be any one of the mobile terminal 200 of FIG. 2, the mobile terminal 300 of FIG. 3 and the mobile terminal 400 of FIG. 4 in accordance with the embodiment.

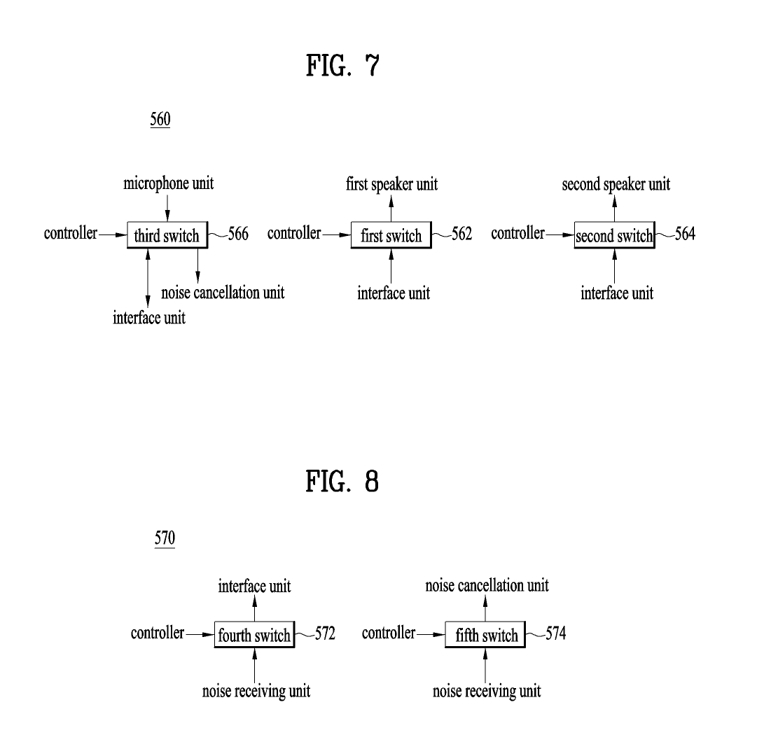

Hereinafter, examples of an earphone, a mobile terminal to which the earphone is applied, and a control method according to one embodiment of the present invention will be described with reference to FIGS. 5 to 22.

FIG. 5 is a view briefly illustrating an earphone connected to the mobile terminal according to one embodiment of the present invention.

As shown in FIG. 5, a portable earphone 500 of the present invention is an earphone having an active noise cancellation function, and is connected with an interface unit of the mobile terminal 600 to enable data communication with the mobile terminal 600.

The earphone 500 includes a noise cancellation unit for cancelling external noise, wherein the noise cancellation unit may be operated by being supplied with a power source from the mobile terminal 600 connected with the earphone 500.

In this case, the noise cancellation unit may cancel noise by receiving external noise, generating a cancellation signal having a phase difference of 180° with respect to the received noise, synthesizing the cancellation signal with an audio signal and outputting the synthesized signal to a speaker of the earphone.

Therefore, the earphone 500 of the present invention may cancel external noise through the noise cancellation unit, and is supplied with a power source from the mobile terminal, whereby a separate battery is not required.

Also, the mobile terminal 600 may identify a type of the earphone 500 by measuring impedance of the earphone 500.

The mobile terminal 600 may supply a power source to the earphone 500 if the type of the earphone 500 is an earphone 500 for noise cancellation, and may block power supply to the earphone 500 if the type of the earphone 500 is a normal earphone 500.

Also, the mobile terminal 500 may control the function of the earphone 500 in accordance with a mode signal which is currently executed.

For example, the earphone 500 may include an earphone jack, a first microphone unit, a second microphone unit, a first speaker unit, a second speaker unit, a noise cancellation unit, and an interface unit.

In this case, the noise cancellation unit may cancel noise component in the periphery of the earphone, and the interface unit may deliver the power source supplied from the mobile terminal to the noise cancellation unit.

The interface unit may change its connection switch with at least any one of the first speaker unit, the second speaker unit and the first microphone unit on the basis of a mode of the mobile terminal through a microphone line of the earphone jack while the power source is being delivered to the noise cancellation unit.

Also, the earphone 500 may include a switch switched to receive an audio output signal from the mobile terminal or transmit an audio signal from the first microphone unit to the mobile terminal through a first line, which is any one of a first audio line of the earphone jack and a second audio line of the earphone jack to deliver the audio output signal from the mobile terminal 600 to the first speaker unit and the second speaker unit.

In this case, the switch may be connected to the second audio line of the earphone jack and the first microphone unit to transmit the audio signal from the first microphone unit to the mobile terminal 600 through the second audio line of the earphone jack in case of a call mode, and may be connected to the second audio line of the earphone jack and the noise cancellation unit to receive the audio output signal from the mobile terminal 600 through the first audio line and the second audio line of the earphone jack in case of a multimedia mode.

The earphone 500 may receive the audio output signal from the mobile terminal 600 through a first line, which is any one of the first audio line and the second audio line, and another second line in a mono type in case of a call mode, and may receive the audio output signal from the mobile terminal 600 through the first line and the second line in a stereo type in case of a multimedia mode.

Next, the earphone 500 may transmit the audio output signal received from the mobile terminal 600 in a mono type through the second line to the first speaker unit and the second speaker unit in case of a call mode.

Also, the earphone 500 may further include a sensing unit for sensing attachment or detachment of the earphone 500. In case of the call mode, at least any one of the first microphone unit and the second microphone unit performs an active noise cancellation (ANC) function for receiving noise in the periphery of the earphone. If any one earphone 500 is attached to or detached from the mobile terminal during a call, the first microphone unit of the earphone 500 which is attached or detached may be used as a microphone for a call, and the second microphone unit may be used as a microphone for ANC. Alternatively, the second microphone unit of the earphone 500 which is attached or detached may be used as a microphone for a call, and the first microphone unit may be used as a microphone for ANC.

Subsequently, the earphone 500 may include a decoding unit that performs decoding by receiving a control signal from the mobile terminal 600 through a first line, which is any one of the first audio line and the second audio line of the earphone jack, in case of a control mode.

In this case, if a connection switch of at least any one of the first speaker unit and the second speaker unit and the interface unit corresponds to a bypass connection of the noise cancellation unit, the earphone 500 may change the connection switch so that the noise cancellation unit may not be bypassed, when the control signal from the mobile terminal 600 is received.

Also, the earphone 500 may re-change the connection switch so that the noise cancellation unit may be bypassed, after the control signal from the mobile terminal 600 is received.

And, the earphone 500 may change the connection switch of at least any one of the first speaker unit and the second speaker unit and the interface unit to output the audio output signal from the mobile terminal 600 to the first speaker unit and the second speaker unit through the first audio line and the second audio line of the earphone jack in case of a bypass mode of the noise cancellation unit.

Meanwhile, the mobile terminal 600 may block a power supply in accordance with a mode signal if the earphone for ANC is connected thereto.

For example, the mobile terminal 600 may avoid unnecessary power consumption by blocking the power supply if the earphone 500 for ANC does not perform the ANC function.

Therefore, the mobile terminal 600 of the present invention enables compatibility of the earphone for ANC and the normal earphone, and is able to control the earphone.

Also, the mobile terminal 600 of the present invention may minimize unnecessary power consumption because a power source is supplied to the earphone only in case of a mode that needs noise cancellation.

For example, the mobile terminal 600 capable of being connected with the earphone 500 may include an audio processor, an earphone socket, an earphone sensor, and an interface unit.

In this case, the earphone sensor may sense an earphone type connected to the earphone socket, and the interface unit may deliver a power source to the earphone in accordance with an earphone type.

The interface unit may change a connection switch of the interface unit and at least any one of the audio processor and the earphone sensor on the basis of an execution mode while the power source is being delivered to the earphone through a microphone line of the earphone socket.

Subsequently, the mobile terminal 600 may include a first switch switched to receive a microphone signal from the earphone or transmit an audio signal from the audio processor through any one of a first audio line and a second audio line of the earphone socket to deliver the microphone signal from the earphone to the audio processor.

In this case, the first switch may be connected to the second audio line of the earphone socket and the earphone sensor to receive the microphone output signal from the earphone 500 through the second audio line of the earphone socket in case of a call mode, and may be connected to the second audio line of the earphone jack and the audio processor to transmit the audio signal from the audio processor through the first audio line and the second audio line of the earphone socket in case of a multimedia mode.

Also, the mobile terminal 600 may transmit the audio signal from the audio processor through any one of the first audio line and the second audio line in a mono type in case of a call mode, and may transmit the audio signal from the audio processor through the first audio line and the second audio line in a stereo type in case of a multimedia mode.

Also, the mobile terminal 600 may include a second switch switched to supply a power source to the earphone through the microphone line of the earphone socket or receive a microphone output signal from the earphone through the microphone line of the earphone socket, to deliver the power source to the earphone 500 in accordance with the earphone type.

Subsequently, the mobile terminal 600 may include an encoding unit that encodes a control signal from the mobile terminal 600 to transmit the control signal to the earphone 500 through a first line, which is any one of the first audio line and the second audio line of the earphone socket, in case of a control mode of the earphone 500.

Also, the earphone sensor may measure impedance of the earphone 500 and identify the earphone type in accordance with the measured impedance value if the earphone 500 is connected thereto.

For example, the earphone sensor may determine the earphone type as an earphone for power supply if the measured impedance value of the earphone is greater than a reference value, and may change the connection switch of the interface unit to supply the power source to the earphone.

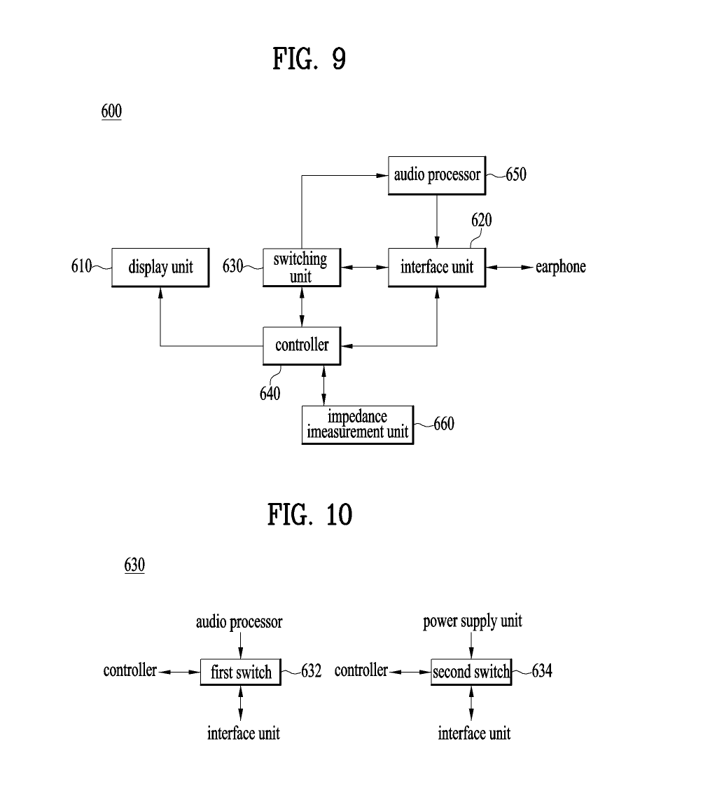

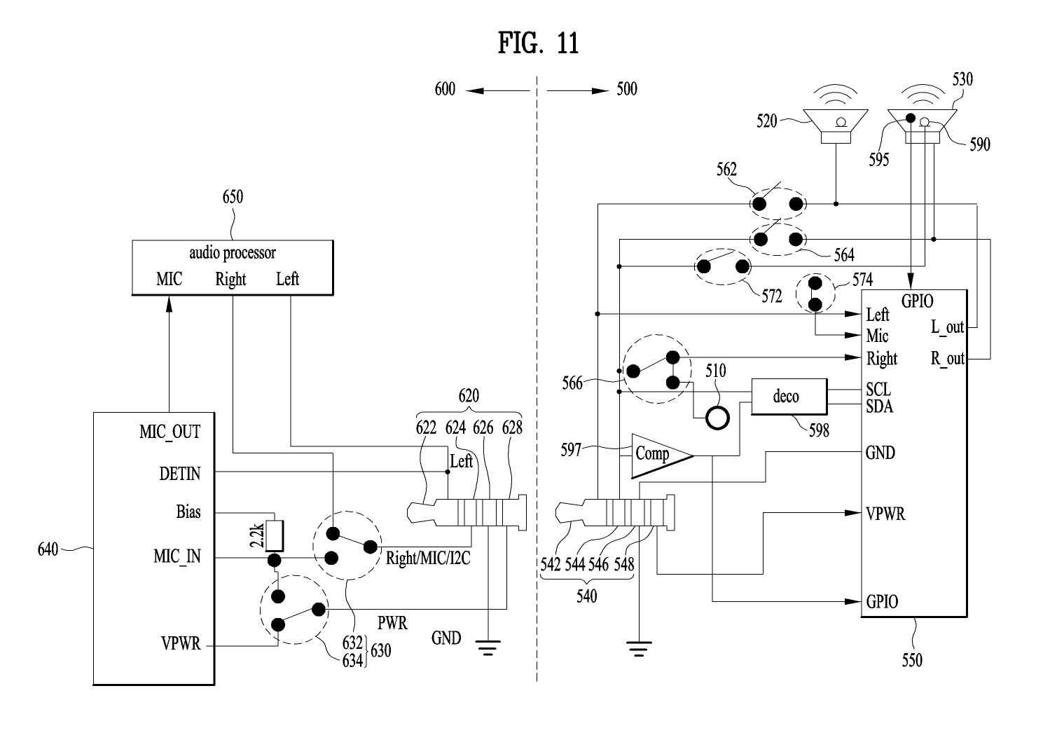

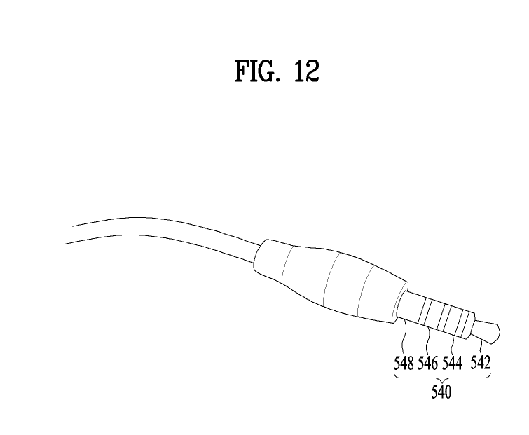

FIG. 6 is a block diagram illustrating component modules of an earphone according to one embodiment of the present invention, FIG. 7 is a schematic block diagram illustrating a first switching unit of FIG. 6, and FIG. 8 is a schematic block diagram illustrating a second switching unit of FIG. 6.

Referring to FIG. 6, the earphone 500 according to one embodiment of the present invention may include a microphone unit 510, first and second speaker units 520 and 530, an interface unit 540, a noise cancellation unit 550, first and second switching units 560 and 570, and a controller 580.

Also, the earphone 500 of the present invention may further include a noise receiving unit 590 and a sensing unit 595.

In this case, the first speaker unit 520 may be a left speaker of the earphone and the second speaker unit 530 may be a right speaker of the earphone. However, the first speaker unit 520 may be a right speaker of the earphone and the second speaker unit 530 may be a left speaker of the earphone, as the case may be.

Next, the interface unit 540 may include an earphone jack connected to the earphone socket of the mobile terminal.

As the case may be, the interface unit 540 may include the first switching unit 560 that includes first, second and third switches 562, 564 and 566, and the second switching unit 570 that includes fourth and fifth switches 572 and 574.

In this case, the earphone jack may be connected to the earphone socket of the mobile terminal, so that the earphone jack may receive a mode signal and a power source from the mobile terminal and transmit a microphone signal of the microphone unit 510 to the mobile terminal.

For example, the earphone jack of the interface unit 540 may be, but not limited to, a four-pole plug that includes a first terminal for receiving a first audio signal from the mobile terminal, a second terminal for receiving a second audio signal from the mobile terminal, a third terminal which is grounded, and a fourth terminal for receiving a power source from the mobile terminal.

The second terminal of the four-pole plug may be an audio line for receiving the mode signal from the mobile terminal or a microphone line for transmitting the microphone signal of the microphone unit 510 to the mobile terminal.

Also, the fourth terminal of the four-pole plug may be a power line for receiving a power source from the mobile terminal or a microphone line for transmitting the microphone signal of the microphone unit 510 to the mobile terminal.

Therefore, the interface unit 540 may deliver the power source supplied from the mobile terminal to the noise cancellation unit 550.

The interface unit 540 may change its connection switch with at least any one of the first speaker unit 520, the second speaker unit 530 and the microphone unit 510 on the basis of a mode of the mobile terminal while the power source is being delivered to the noise cancellation unit 550 through a microphone line of the earphone jack.

Subsequently, the noise cancellation unit 550 may be supplied with a power source of the mobile terminal through the earphone jack of the interface unit 540 to cancel a noise component applied from at least any one of the first and second speaker units 520 and 530.

For example, the noise cancellation unit 550 may cancel an external noise component received from the noise receiving unit 590 if the noise receiving unit 590 is provided in at least any one of the first and second speaker units 520 and 530.

In this case, if the noise receiving unit 590 receives external noise, the noise cancellation unit 550 may cancel external noise by receiving external noise from the noise receiving unit 590, generating a cancellation signal having a phase difference of 180° with respect to the received noise, synthesizing the cancellation signal with an audio signal and outputting the synthesized signal to a speaker of the earphone.

Next, the first switching unit 560 may switch a signal passing through the interface unit 540 and the first and second switching units 520 and 530, and the second switching unit 570 may switch a signal passing through the interface unit 540 and the noise cancellation unit 550 or the microphone unit 510.

For example, as shown in FIG. 7, the first switching unit 560 may include first, second and third switches 562, 564 and 566.

In this case, the first switch 562 may switch a signal between the interface unit 540 and the first speaker unit 520, and the second switch 564 may switch a signal between the interface unit 540 and the second speaker unit 530.

At this time, the first and second switches 562 and 564 may be one way switches.

The third switch 566 may switch a signal between the interface unit 540 and the noise cancellation unit 550 or the microphone unit 510.

At this time, the third switch 566 may be a three-way switch.

The first, second and third switches 562, 564 and 566 may be controlled in accordance with a control signal of the controller 580.

For example, the third switch 566 may be switched to receive the audio output signal from the mobile terminal or transmit the audio signal from the microphone unit 510 to the mobile terminal through a first line, which is any one of the first audio line and the second audio line of the earphone jack, to deliver the audio output signal from the mobile terminal to the first speaker unit 520 and the second speaker unit 530.

In this case, the third switch 566 may be connected to the second audio line of the earphone jack and the microphone unit 510 to transmit the audio signal from the microphone unit 510 to the mobile terminal through the second audio line of the earphone jack in case of a call mode, and may be connected to the second audio line of the earphone jack and the noise cancellation unit 550 to receive the audio output signal from the mobile terminal through the first audio line and the second audio line of the earphone jack in case of a multimedia mode.

Also, as an example, if the mode signal received from the mobile terminal is a call mode signal and the signal sensed by the sensing unit 595 is a detachment signal of the earphone 500, the controller 580 of the earphone 500 may control the third switch 566 such that connection between the interface unit 540 and the microphone unit 510 is turned off and connection between the interface unit 540 and the noise cancellation unit 550 is turned on.

The earphone 500 may further include a sensing unit 595 for sensing attachment or detachment of the earphone 500.

The earphone 500 may further include another microphone unit in addition to the microphone unit 510. Another microphone unit may be a noise receiving unit 590 for receiving noise in the periphery of the earphone 500.

For example, the earphone 500 may perform an ANC (Active Noise Cancellation) function for receiving noise in the periphery of the earphone in at least any one of the microphone unit 510 which is the first microphone unit and the noise receiving unit 590 which is the second microphone unit in case of a call mode.

Also, if any one earphone 500 is attached to or detached from the mobile terminal during a call, the microphone unit 510 which is the first microphone unit of the earphone 500 which is attached or detached may be used as a microphone for a call, and the noise receiving unit 590 which is the second microphone unit may be used as a microphone for ANC. Alternatively, the noise receiving unit 590 which is the second microphone unit of the earphone 500 which is attached or detached may be used as a microphone for a call, and the microphone unit 510 which is the first microphone unit may be used as a microphone for ANC.

As the case may be, if the mode signal received from the mobile terminal is a call mode signal, the controller 580 of the earphone 500 may turn off the first and second switches 562 and 564, and may control the third switch 566 such that connection between the interface unit 540 and the microphone unit 510 is turned on and connection between the interface unit 540 and the noise cancellation unit 550 is turned off.

As another case, if the mode signal received from the mobile terminal is a multimedia mode signal, the controller 580 of the earphone 500 may turn off the first and second switches 562 and 564, and may control the third switch 566 such that connection between the interface unit 540 and the microphone unit 510 is turned off and connection between the interface unit 540 and the noise cancellation unit 550 is turned on.

As an example, the earphone 500 may receive the audio output signal from the mobile terminal through a first line, which is any one of the first audio line and the second audio line, and another second line in a mono type in case of a call mode, and may receive the audio output signal from the mobile terminal through the first line and the second line in a stereo type in case of a multimedia mode.

The earphone 500 may transmit the audio output signal from the mobile terminal, which is received in a mono type through the second line, to the first speaker unit 520 and the second speaker unit 530.

As still another case, if the mode signal received from the mobile terminal is a control mode signal, the controller 580 of the earphone 500 may turn off the first and second switches 562 and 564, and may control the third switch 566 such that connection between the interface unit 540 and the microphone unit 510 is turned on and connection between the interface unit 540 and the noise cancellation unit 550 is turned off.

As further still another case, if the mode signal received from the mobile terminal is a bypass mode signal, the controller 580 of the earphone 500 may turn on the first and second switches 562 and 564, and may control the third switch 566 such that connection between the interface unit 540 and the microphone unit 510 is turned off and connection between the interface unit 540 and the noise cancellation unit 550 is turned on.

For example, the earphone 500 may include a decoding unit that performs decoding by receiving a control signal from the mobile terminal 600 through a first line, which is any one of the first audio line and the second audio line of the earphone jack, in case of a control mode.

In this case, if a connection switch of at least any one of the first speaker unit 520 and the second speaker unit 530 and the interface unit 540 corresponds to bypass connection of the noise cancellation unit 550, the earphone 500 may change the connection switch so that the noise cancellation unit 550 may not be bypassed, when the control signal from the mobile terminal is received.

At this time, the change of the connection switch may be a change from ON state of the first and second switches 562 and 564 to OFF state thereof.

Also, the earphone 500 may re-change the connection switch so that the noise cancellation unit may be bypassed, after the control signal from the mobile terminal 600 is received.

At this time, the re-change of the connection switch may be a change from OFF state of the first and second switches 562 and 564 to ON state thereof.

The earphone 500 may change a connection switch of the interface unit 540 and at least any one of the first speaker unit 520 and the second speaker unit 530 to output the audio output signal from the mobile terminal to the first speaker unit and the second speaker unit through the first audio line and the second audio line of the earphone jack in case of a bypass mode of the noise cancellation unit.

At this time, the change of the connection switch may be a change from OFF state of the first and second switches 562 and 564 to ON state thereof.

Also, as shown in FIG. 8, the second switching unit 570 may include fourth and fifth switches 572 and 574.

In this case, the fourth switch 572 may switch a signal between the noise receiving unit 590 and the interface unit 540.

At this time, the fourth switch 572 may be connected with the second switch 564 of the first switching unit 560 in parallel.

The fifth switch 574 may switch a noise signal between the noise receiving unit 590 and the noise cancellation unit 550.

At this time, the fourth and fifth switches 572 and 574 may be one way switches, and may be controlled in accordance with the control signal of the controller 580.

As an example, if the mode signal received from the mobile terminal is a call mode signal and the signal sensed by the sensing unit 595 is a detachment signal of the earphone 500, the controller 580 of the earphone 500 may turn on the fourth switch 572 and turn off the fifth switch 574, whereby the noise receiving unit 590 may be used as a microphone for a call.

Next, the noise receiving unit 590 may receive peripheral noise.

In this case, the noise receiving unit 590 may be provided respectively at inner sides of the first and second speaker units 520 and 530, or may be provided only at any one of the first and second speaker units 520 and 530.

As another case, the noise receiving unit 590 may be provided separately at an outer side of the earphone without being provided in the first and second speaker units 520 and 530.

In this case, the noise receiving unit 590 may be used as a microphone for ANC or a microphone for a call when the earphone 500 is attached or detached.

Also, the sensing unit 595 may sense attachment or detachment of the earphone.

For example, the sensing unit 595 may be, but not limited to, a proximity sensor.

In this case, the sensing unit 595 may be provided respectively at inner sides of the first and second speaker units 520 and 530, or may be provided only at any one of the first and second speaker units 520 and 530.

As another case, the sensing unit 595 may be provided separately at an outer side of the earphone without being provided in the first and second speaker units 520 and 530.

As still another case, the noise receiving unit 590 and the sensing unit 595 may be provided in the same speaker unit of the first and second speaker units 520 and 530.

As another example, the noise receiving unit 590 and the sensing unit 595 may be provided in their respective speaker units of the first and second speaker units 520 and 530.

Subsequently, the controller 580 may control the first and second switching units 560 and 570 in accordance with the mode signal received from the mobile terminal.

In this case, the controller 580 may further include a decoding unit for decoding the mode signal received from the interface unit 540.

As the case may be, the decoding unit may be arranged separately without being included in the controller 580.

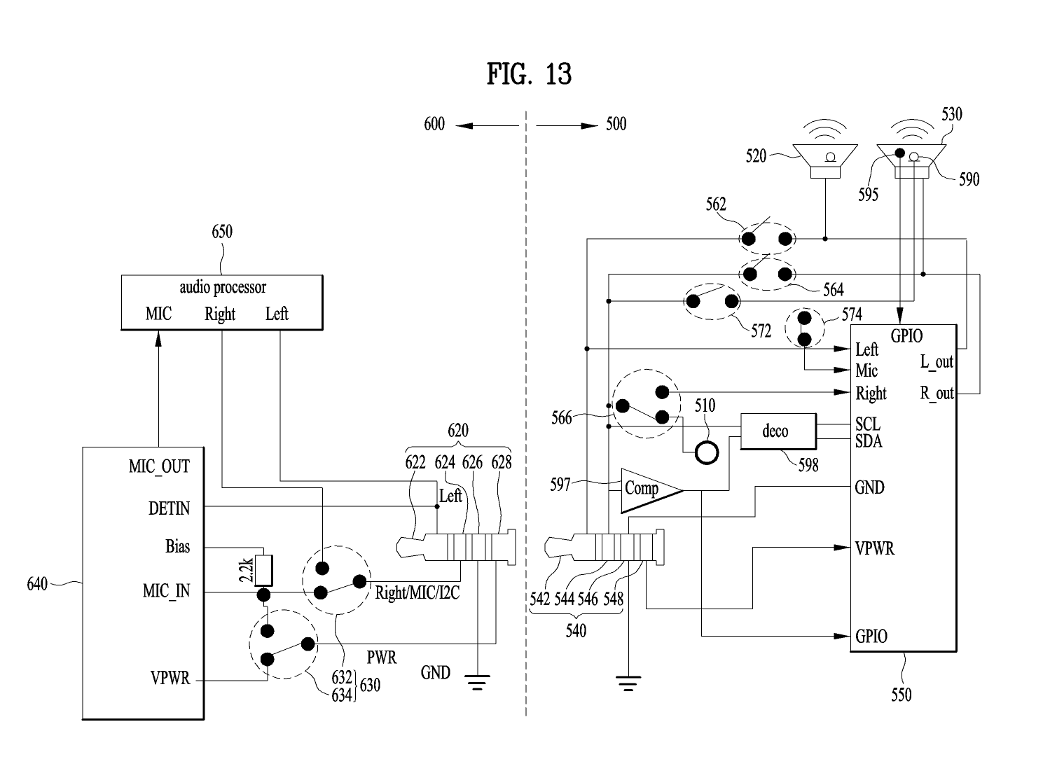

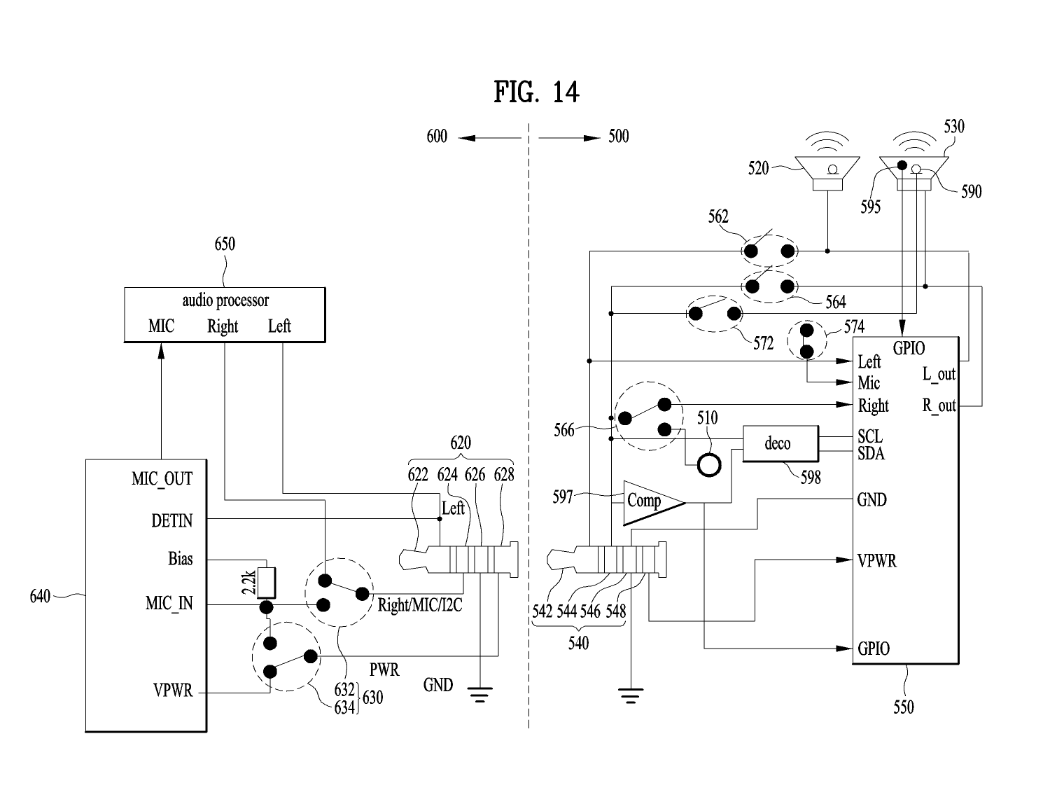

FIG. 9 is a block diagram illustrating component modules of a mobile terminal according to one embodiment of the present invention, and FIG. 10 is a block diagram illustrating a switching unit of FIG. 9.

Referring to FIG. 9, the mobile terminal 600 according to one embodiment of the present invention may include a display unit 610, an interface unit 620, a switching unit 630, a controller 640, and an audio processor 650.

As the case may be, the mobile terminal 600 may further include an impedance measurement unit 660.

For example, the impedance measurement unit 660 and the controller 640 may be included in the earphone sensor for sensing the earphone type.

In this case, the display unit 610 may display a screen according to an execution mode which is currently executed.

The interface unit 620 may include an earphone socket connected to the earphone jack of the earphone.

As the case may be, the interface unit 620 may include a switching unit 630 that includes first and second switches 632 and 634.

In this case, the earphone socket may be connected to the earphone jack of the earphone, so that the earphone socket may transmit a mode signal and a power source according to the execution mode to the earphone.

For example, the earphone socket of the interface unit 620 may be, but not limited to, a four-pole socket that includes a first terminal for transmitting a first audio signal to the earphone, a second terminal for transmitting a second audio signal to the earphone, a third terminal which is grounded, and a fourth terminal for transmitting a power source to the earphone.

In this case, the first, second, third and fourth terminals may be arranged sequentially from an end of the four-pole socket.

The second terminal of the four-pole socket may be an audio line for transmitting the mode signal to the earphone or a microphone line for receiving the microphone signal from the earphone.

Also, the fourth terminal of the four-pole socket may be a power line for transmitting a power source to the earphone or a microphone line for receiving a microphone output signal of the earphone.

Therefore, the interface unit 540 may deliver the power source to the earphone in accordance with the earphone type.

As the case may be, the first terminal of the four-pole socket may electrically be connected to the first audio signal line, and the second and fourth terminals may electrically be connected to the switching unit 630.

For example, the interface unit 540 may change its connection switch with at least any one of the audio processor 650 and the controller 640 on the basis of the execution mode while the power source is being delivered to the earphone through a microphone line of the earphone socket.

Next, the switching unit 630 may switch connection between the interface unit 620 and an audio signal transmission line or a microphone signal transmission line, and may switch connection between the interface unit 620 and the microphone signal transmission line or a power supply line.

In this case, the microphone signal transmission line may be connected with a mode signal transmission line that transmits the mode signal generated from the controller 640.

For example, as shown in FIG. 10, the switching unit 630 may include first and second switches 632 and 634.

In this case, the first switch 632 may switch a signal between the interface unit 620 and a second audio signal line of the audio processor 650 or the microphone signal transmission line.

The second switch 634 may switch a signal between the interface unit 620 and the microphone signal transmission line or the power supply line.

At this time, the first and second switches 632 and 634 may be three-way switches, and may be controlled in accordance with the control signal of the controller 640.

For example, the first switch 632 may be switched to receive the microphone signal from the earphone or transmit the audio signal from the audio processor to the earphone through any one of the first audio line and the second audio line of the earphone socket to deliver the microphone signal from the earphone to the audio processor 650.

In this case, the first switch 632 may be connected to the second audio line of the earphone socket and the controller 640 to receive the microphone output signal from the earphone through the second audio line of the earphone socket in case of a call mode, and may be connected to the second audio line of the earphone jack and the audio processor 650 to transmit the audio signal from the audio processor 650 through the first audio line and the second audio line of the earphone socket in case of a multimedia mode.

Also, the second switch 634 may be switched to supply a power source to the earphone through the microphone line of the earphone socket or receive a microphone output signal from the earphone through the microphone line of the earphone socket, to deliver the power source to the earphone in accordance with the earphone type.

For example, if the current execution mode is a call mode and the earphone type is an earphone for noise cancellation, the controller 640 of the earphone sensor may control the first switch 632 such that connection between the interface unit 620 and the second audio signal line of the audio processor 650 is turned off and connection between the interface unit 620 and the microphone signal transmission line is turned on, and may control the second switch 634 such that connection between the interface unit 620 and the microphone signal transmission line is turned off and connection between the interface unit 620 and the power supply line is turned on.

As the case may be, if the current execution mode is a multimedia mode and the earphone type is an earphone for noise cancellation, the controller 640 of the earphone sensor may control the first switch 632 such that connection between the interface unit 620 and the second audio signal line of the audio processor 650 is turned on and connection between the interface unit 620 and the microphone signal transmission line is turned off, and may control the second switch 634 such that connection between the interface unit 620 and the microphone signal transmission line is turned off and connection between the interface unit 620 and the power supply line is turned on.

For example, the mobile terminal 600 may transmit the audio signal from the audio processor through any one of the first audio line and the second audio line in a mono type in case of a call mode, and may transmit the audio signal from the audio processor through the first audio line and the second audio line in a stereo type in case of a multimedia mode.

As another case, if the current execution mode is a control mode of the earphone and the earphone type is an earphone for noise cancellation, the controller 640 of the earphone sensor may control the first switch 632 such that connection between the interface unit 620 and the second audio signal line of the audio processor 650 is turned off and connection between the interface unit 620 and the microphone signal transmission line is turned on, and may control the second switch 634 such that connection between the interface unit 620 and the microphone signal transmission line is turned off and connection between the interface unit 620 and the power supply line is turned on.

For example, the mobile terminal 600 may include an encoding unit that encodes a control signal from the mobile terminal 600 to transmit the control signal to the earphone through a first line, which is any one of the first audio line and the second audio line of the earphone socket, in case of a control mode of the earphone.

As another case, if the current execution mode is a noise cancellation bypass mode and the earphone type is an earphone for noise cancellation, the controller 640 may control the first switch 632 such that connection between the interface unit 620 and the second audio signal line of the audio processor 650 is turned on and connection between the interface unit 620 and the microphone signal transmission line is turned off, and may control the second switch 634 such that connection between the interface unit 620 and the microphone signal transmission line is turned off and connection between the interface unit 620 and the power supply line is turned on.

As still another case, if the earphone type is not an earphone for noise cancellation, the controller 640 may control the first switch 632 such that connection between the interface unit 620 and the second audio signal line of the audio processor 650 is turned on and connection between the interface unit 620 and the microphone signal transmission line is turned off, and may control the second switch 634 such that connection between the interface unit 620 and the microphone signal transmission line is turned on and connection between the interface unit 620 and the power supply line is turned off.

Meanwhile, the earphone sensor may include the controller 640 and an impedance measurement unit 660.

The controller 640 of the earphone sensor may control the display unit 610, the interface unit 620 and the switching unit 630.

In this case, the controller 640 may control the switching unit 630 by determining the presence of a power supply to the earphone in accordance with the earphone type connected to the interface unit 620, and may control the switching unit 630 in accordance with the mode signal according to the execution mode.

For example, the controller 640 may generate a mode signal for the current execution mode and control the switching unit 630 in accordance with the generated mode signal, and may control the interface unit 620 to transmit the generated mode signal to the mobile terminal.

In this case, the controller 640 may determine the power supply to the earphone in accordance with the earphone type and then generate the mode signal for the current execution mode.

Next, the audio processor 650 may process the first and second audio signals and the microphone signal.

In this case, the first audio signal may be a signal transmitted to the left speaker of the earphone, and the second audio signal may be a signal transmitted to the right speaker of the earphone. However, as the case may be, the first audio signal may be a signal transmitted to the right speaker of the earphone, and the second audio signal may be a signal transmitted to the left speaker of the earphone.

The impedance measurement unit 660 of the earphone sensor may measure impedance of the earphone if the earphone jack is connected to the earphone socket.

In this case, the impedance measurement unit 660 may be included in the controller 640, or may be arranged separately.

For example, the controller 640 may identify the earphone type in accordance with the impedance value measured by the impedance measurement unit 660 if the earphone is connected thereto.

In this case, the controller 640 may determine the earphone type as an earphone for noise cancellation if the measured impedance value of the earphone is greater than a reference value, and may control the switching unit 630 to supply a power source to the earphone.

As the case may be, the controller 640 may measure a first impedance value for an audio terminal of the interface unit 620 of the earphone and a second impedance value for a microphone terminal. If the first impedance value is greater than a first reference value and the second impedance value is greater than a second reference value, the controller 640 may determine the earphone type as an earphone for noise cancellation and control the switching unit 630 to supply the power source to the earphone.

Also, the mobile terminal 600 may include an encoding unit for encoding the mode signal generated from the controller 640.

In this case, the encoding unit may be included in the controller 640, or may be arranged separately.

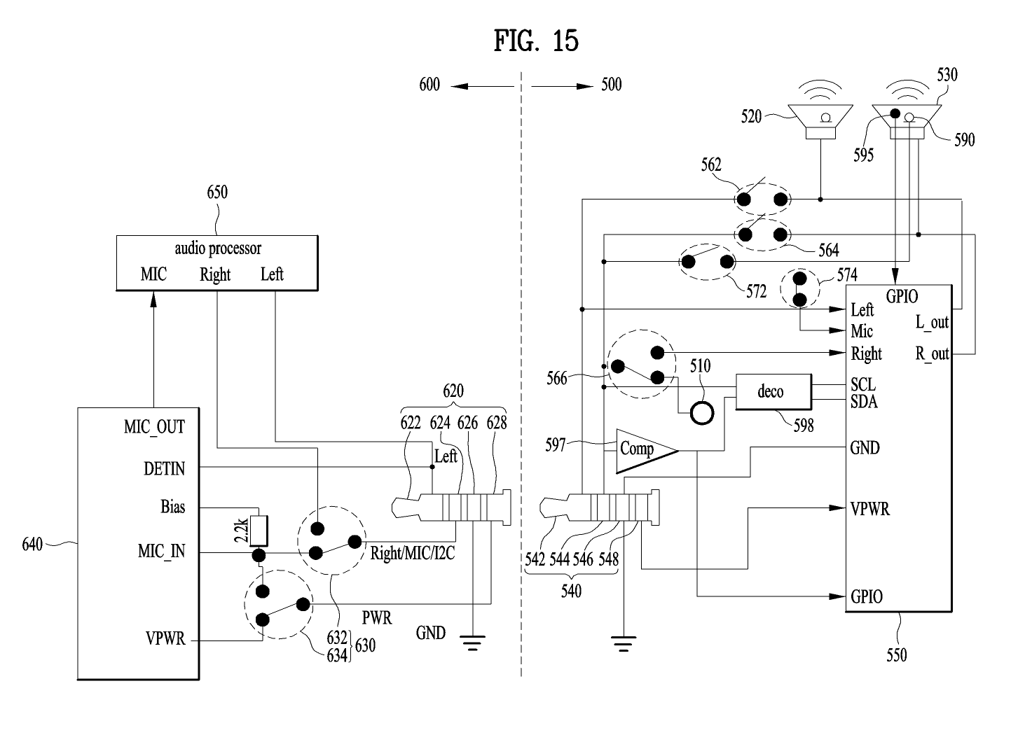

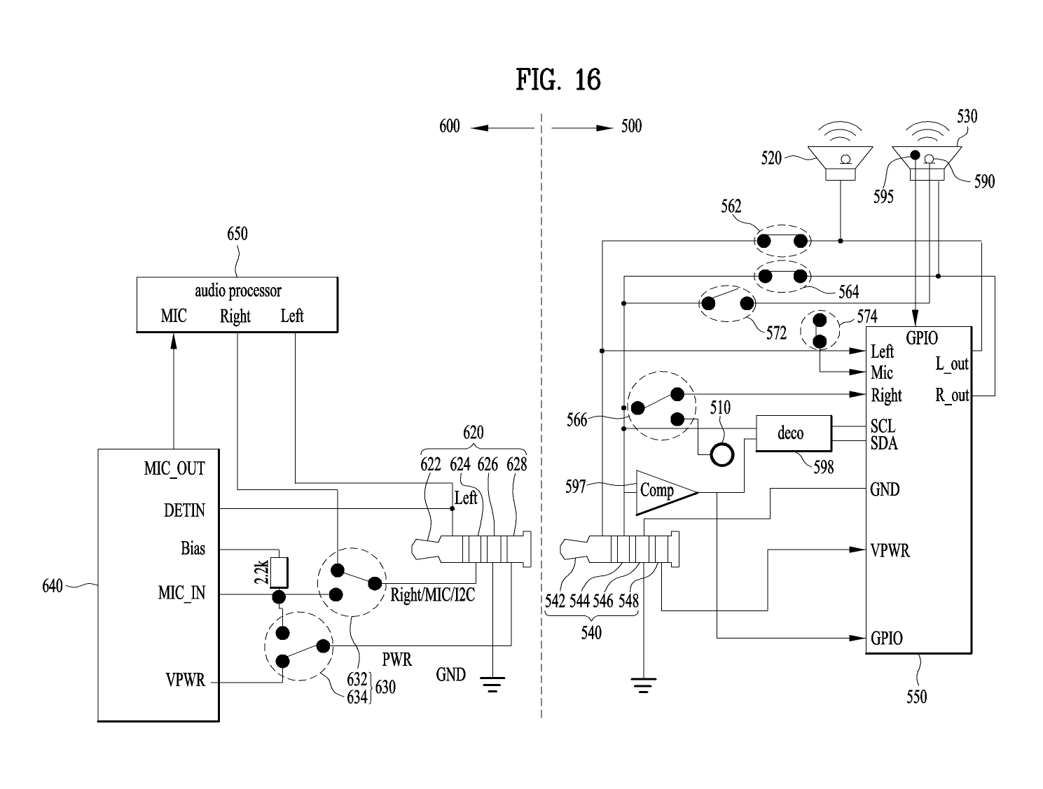

FIG. 11 is a view illustrating circuit connection between a mobile terminal and an earphone according to one embodiment of the present invention, and FIG. 12 is a view illustrating an interface unit of an earphone.

As shown in FIG. 11, the earphone 500 may include a microphone unit 510, first and second speaker units 520 and 530, an interface unit 540, a noise cancellation unit 550, first and second switching units 560 and 570, a controller (not shown), a noise receiving unit 590, and a sensing unit 595.

In this case, the first speaker unit 520 may be a left speaker of the earphone and the second speaker unit 530 may be a right speaker of the earphone.

Next, the interface unit 540 may include an earphone jack. As shown in FIG. 12, the earphone jack may be a four-pole plug that includes a first terminal 542 for receiving a first audio signal from the mobile terminal, a second terminal 544 for receiving a second audio signal from the mobile terminal, a third terminal 546 which is grounded, and a fourth terminal 548 for receiving a power source from the mobile terminal.

In this case, the first, second, third and fourth terminals 542, 544, 546 and 548 may be arranged sequentially from an end of the four-pole socket.

The second terminal 544 may be an audio line for receiving the mode signal from the mobile terminal or a microphone line for transmitting the microphone signal to the mobile terminal.

Subsequently, the noise cancellation unit 550 may be supplied with a power source of the mobile terminal through the interface unit 540 to cancel a noise component applied from at least any one of the first and second speaker units 520 and 530.

Next, the first switch 562 may switch a signal between the interface unit 540 and the first speaker unit 520, and the second switch 564 may switch a signal between the interface unit 540 and the second speaker unit 530.

At this time, the first and second switches 562 and 564 may be one way switches.

The third switch 566 may switch a signal between the interface unit 540 and the noise cancellation unit 550 or the microphone unit 510.

At this time, the third switch 566 may be a three-way switch.

The first, second and third switches 562, 564 and 566 may be controlled in accordance with a control signal of the controller (not shown).

The fourth switch 572 may switch a signal between the noise receiving unit 590 and the interface unit 540.

At this time, the fourth switch 572 may be connected with the second switch 564 of the first switching unit 560 in parallel.

The fifth switch 574 may switch a signal between the noise receiving unit 590 and the noise cancellation unit 550.

At this time, the fourth and fifth switches 572 and 574 may be one way switches, and may be controlled in accordance with the control signal of the controller.

Next, the noise receiving unit 590 may receive peripheral noise, and may be provided at an inner side of the second speaker unit 530.

Also, the sensing unit 595 may sense attachment or detachment of the earphone, and may be provided at an inner side of the second speaker unit 530.

For example, the sensing unit 595 may be, but not limited to, a proximity sensor.

Therefore, the noise receiving unit 590 and the sensing unit 595 may be provided together with the second speaker unit 530.

Subsequently, the controller may include a decoding unit for decoding the mode signal received from the interface unit 540.

For example, the decoding unit may include a comparator 597 and a decoder 598.

In this way, the interface unit of the earphone may deliver the power source supplied from the mobile terminal to the noise cancellation unit.

The interface unit of the earphone may change its connection switch with at least any one of the first speaker unit, the second speaker unit and the microphone unit on the basis of a mode of the mobile terminal through a microphone line of the earphone jack while the power source is being delivered to the noise cancellation unit.

Meanwhile, the mobile terminal 600 may include an interface unit 620, a switching unit 630, a controller 640, and an audio processor 650.

As the case may be, the mobile terminal 600 may further include an impedance measurement unit.

In this case, the mobile terminal 600 may include an earphone sensor for sensing an earphone type, wherein the earphone sensor may include a controller 640 and an impedance measurement unit.

The interface unit 620 may include an earphone socket. The earphone socket may be a four-pole socket that includes a first terminal 622 for transmitting a first audio signal to the earphone, a second terminal 624 for transmitting a second audio signal to the earphone, a third terminal 626 which is grounded, and a fourth terminal 628 for transmitting a power source to the earphone.

In this case, the second terminal 624 of the four-pole socket may be an audio line for transmitting the mode signal to the earphone or a microphone line for receiving the microphone signal from the earphone.

Also, the first terminal 622 of the four-pole socket may electrically be connected to the first audio signal line of the audio processor 650, and the second and fourth terminals 624 and 628 may electrically be connected to the switching unit 630.

Next, the switching unit 632 may include first and second switches 632 and 634.

In this case, the first switch 632 may switch a signal between the interface unit 620 and a second audio signal line of the audio processor 650 or the microphone signal transmission line.

The microphone signal transmission line may be connected with a mode signal transmission line for transmitting the mode signal generated from the controller 640.

The second switch 634 may switch a signal between the interface unit 620 and the microphone signal transmission line or the power supply line.

At this time, the first and second switches 632 and 634 may be three-way switches, and may be controlled in accordance with the control signal of the controller 640.

Subsequently, the controller 640 may control the switching unit 630 by determining the presence of a power supply to the earphone in accordance with the earphone type connected to the interface unit 620, and may control the switching unit 630 in accordance with the mode signal according to the execution mode.

For example, the controller 640 may generate a mode signal for the current execution mode and control the switching unit 630 in accordance with the generated mode signal, and may control the interface unit 620 to transmit the generated mode signal to the mobile terminal.

In this case, the controller 640 may determine the power supply to the earphone in accordance with the earphone type and then generate the mode signal for the current execution mode.

For example, the controller 640 may identify the earphone type in accordance with an impedance value measured by the impedance measurement unit if the earphone is connected thereto.

In this case, the controller 640 may determine the earphone type as an earphone for noise cancellation if the measured impedance value of the earphone is greater than a reference value, and may control the switching unit 630 to supply the power source to the earphone.

Next, the audio processor 650 may process the first and second audio signals and the microphone signal.

In this case, the first audio signal may be a signal transmitted to the left speaker of the earphone, and the second audio signal may be a signal transmitted to the right speaker of the earphone.

In this way, the interface unit of the mobile terminal may deliver the power source to the earphone in accordance with the earphone type.

The interface unit of the mobile terminal may change its connection switch with at least any one of the audio processor and the earphone sensor on the basis of the execution mode through a microphone line of the earphone socket while the power source is being delivered to the earphone.

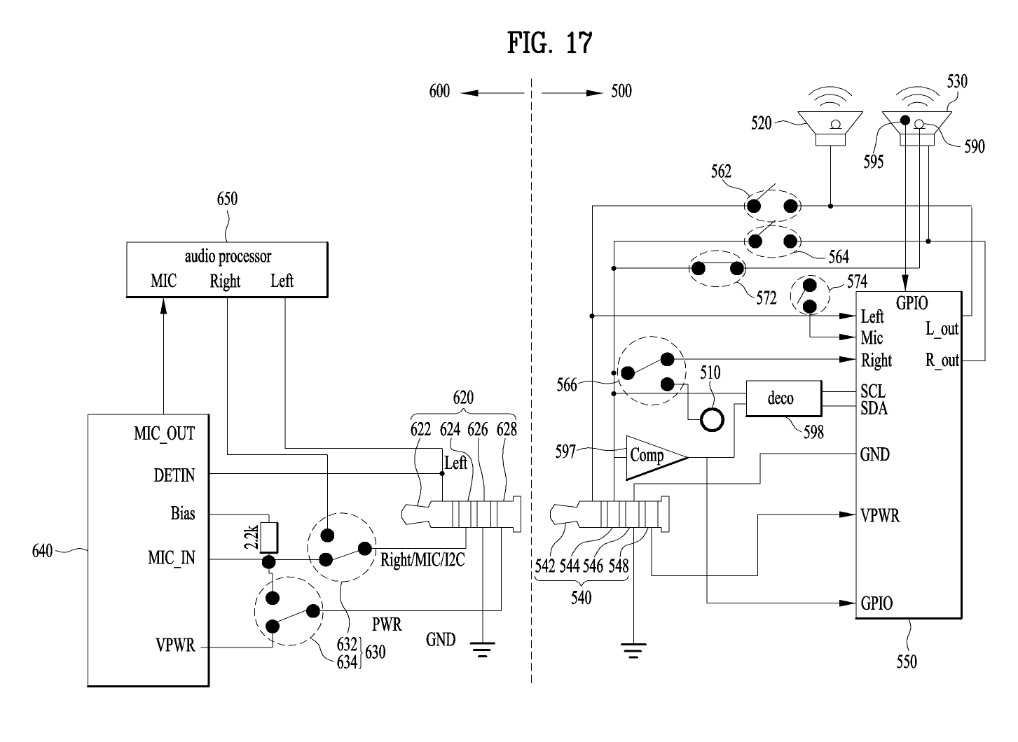

FIGS. 13 to 16 are views illustrating circuit connection between a mobile terminal and an earphone according to a mode of a mobile terminal.

FIG. 13 illustrates circuit connection between the mobile terminal and the earphone when the mobile terminal is in a call mode.

As shown in FIG. 13, if the interface unit 540 of the earphone 500 is connected to the interface unit 620 of the mobile terminal 600, the controller 640 of the mobile terminal 600 analyzes the current execution mode of the mobile terminal 600 and a type of the earphone 500.

In this case, the controller 640 of the mobile terminal 600 may determine the current execution mode by identifying the mode which is currently executed on the display screen when analyzing the current execution mode.

Also, the controller 640 of the mobile terminal 600 may identify the current type of the earphone in accordance with the impedance value of the earphone, which is measured by the impedance measurement unit, when analyzing the type of the earphone 500.

For example, if the measured impedance value of the earphone is greater than the reference value, the controller 640 of the mobile terminal 600 may determine the earphone type as an earphone for noise cancellation and control the switching unit 630 to supply the power source to the earphone.

As the case may be, the controller 640 of the mobile terminal 600 may measure a first impedance value for a first terminal (audio terminal) 542 of the interface unit 540 of the earphone 500 and a second impedance value for a fourth terminal (microphone terminal) 544 if the earphone 500 is connected thereto. If the first impedance value is greater than a first reference value and the second impedance value is greater than a second reference value, the controller 640 may determine the earphone type as an earphone for noise cancellation and control the switching unit 630 to supply the power source to the earphone 500.

Subsequently, if the current execution mode is a call mode and the earphone type is an earphone for noise cancellation, the controller 640 of the mobile terminal 600 controls the first switch 632 such that connection between the second terminal 624 of the interface unit 620 and the second audio signal line of the audio processor 650 is turned off and connection between the second terminal 624 of the interface unit 620 and the microphone signal transmission line is turned on, and controls the second switch 634 such that connection between the fourth terminal 628 of the interface unit 620 and the microphone signal transmission line is turned off and connection between the fourth terminal 628 of the interface unit 620 and the power supply line is turned on.

In this case, the microphone signal transmission line may be connected with a mode signal transmission line for transmitting the mode signal generated from the controller 640.

Therefore, the controller 640 of the mobile terminal 600 generates a mode signal for the current execution mode and transmits the generated mode signal to the earphone 500 through the mode signal transmission line connected to the controller 640 and the second terminal 624 of the interface unit 620.

The controller 640 of the mobile terminal 600 supplies the power source to the earphone 500 through the fourth terminal 628 of the interface unit 620.

Next, the controller of the earphone identifies the mode signal of the mobile terminal 600, which is received through the second terminal 544 of the interface unit 540.

In this case, the mode signal is received through the second terminal 544 of the interface unit 540, and is applied to the controller of the earphone 500 through a decoding unit that includes a comparator 597 and a decoder 598.

At this time, the controller of the earphone 500 may be included in the noise cancellation unit 550.

The noise cancellation unit 550 may be supplied with the power source applied through the fourth terminal 548 of the interface unit 540.

Next, if the mode signal received from the mobile terminal 600 is a call mode signal, the controller of the earphone 500 turns off the first and second switches 562 and 564, and controls the third switch 566 such that connection between the second terminal 544 of the interface unit 540 and the microphone unit 510 is turned on and connection between the second terminal 544 of the interface unit 540 and the noise cancellation unit 550 is turned off.

Also, the controller of the earphone 500 turns on the fifth switch 574 connected between the noise receiving unit 590 and the noise cancellation unit 550 to transmit a noise signal received from the noise receiving unit 590 to the noise cancellation unit 550.

Therefore, if the mobile terminal 600 corresponds to the call mode, the first audio signal of the mobile terminal 600 may be transmitted to the first speaker unit 520 through L terminal of the audio processor 650, the first terminal 622 of the interface unit 620, the first terminal 542 of the interface unit 540, and L terminal of the noise cancellation unit 550.

The microphone signal of the earphone may be transmitted to the audio processor 650 through the microphone unit 510, the third switch 566, the second terminal 544 of the interface unit 540, the second terminal 624 of the interface unit 620, the first switch 632, and the controller 640.

Subsequently, the noise signal in the periphery of the earphone 500 may be transmitted to the noise cancellation unit 550 through the noise receiving unit 590 and the fifth switch 574.

FIG. 14 illustrates circuit connection between the mobile terminal and the earphone when the mobile terminal is in a multimedia mode.

As shown in FIG. 14, if the current execution mode is a multimedia mode and the earphone type is an earphone for noise cancellation, the controller 640 of the mobile terminal 600 controls the first switch 632 such that connection between the second terminal 624 of the interface unit 620 and the second audio signal line of the audio processor 650 is turned on and connection between the second terminal 624 of the interface unit 620 and the microphone signal transmission line is turned off, and controls the second switch 634 such that connection between the fourth terminal 628 of the interface unit 620 and the microphone signal transmission line is turned off and connection between the fourth terminal 628 of the interface unit 620 and the power supply line is turned on.

In this case, the microphone signal transmission line may be connected with a mode signal transmission line for transmitting the mode signal generated from the controller 640.

Therefore, the controller 640 of the mobile terminal 600 generates a mode signal for the current execution mode and transmits the generated mode signal to the earphone 500 through the mode signal transmission line connected to the controller 640 and the second terminal 624 of the interface unit 620.

The controller 640 of the mobile terminal 600 supplies the power source to the earphone 500 through the fourth terminal 628 of the interface unit 620.

Next, the controller of the earphone 500 identifies the mode signal of the mobile terminal 600, which is received through the second terminal 544 of the interface unit 540.

In this case, the mode signal is received through the second terminal 544 of the interface unit 540, and is applied to the controller of the earphone 500 through a decoding unit that includes a comparator 597 and a decoder 598.

At this time, the controller of the earphone 500 may be included in the noise cancellation unit 550.

The noise cancellation unit 550 may be supplied with the power source applied through the fourth terminal 548 of the interface unit 540.

Next, if the mode signal received from the mobile terminal 600 is a multimedia mode signal, the controller of the earphone 500 turns off the first and second switches 562 and 564, and controls the third switch 566 such that connection between the second terminal 544 of the interface unit 540 and the microphone unit 510 is turned off and connection between the second terminal 544 of the interface unit 540 and the noise cancellation unit 550 is turned on.

Also, the controller of the earphone 500 turns on the fifth switch 574 connected between the noise receiving unit 590 and the noise cancellation unit 550 to transmit a noise signal received from the noise receiving unit 590 to the noise cancellation unit 550.

Therefore, if the mobile terminal 600 corresponds to the multimedia mode, the first audio signal of the mobile terminal 600 may be transmitted to the first speaker unit 520 through L terminal of the audio processor 650, the first terminal 622 of the interface unit 620, the first terminal 542 of the interface unit 540, and L terminal of the noise cancellation unit 550.

The second audio signal of the mobile terminal 600 may be transmitted to the second speaker unit 530 through R terminal of the audio processor 650, the first switch 632, the second terminal 624 of the interface unit 620, the second terminal 544 of the interface unit 540, the third switch 566 and R terminal of the noise cancellation unit 550.

Subsequently, the noise signal in the periphery of the earphone 500 may be transmitted to the noise cancellation unit 550 through the noise receiving unit 590 and the fifth switch 574.

FIG. 15 illustrates circuit connection between the mobile terminal and the earphone when the mobile terminal is in a control mode.

As shown in FIG. 15, if the current execution mode is a control mode and the earphone type is an earphone for noise cancellation, the controller 640 of the mobile terminal 600 controls the first switch 632 such that connection between the second terminal 624 of the interface unit 620 and the second audio signal line of the audio processor 650 is turned off and connection between the second terminal 624 of the interface unit 620 and the microphone signal transmission line is turned on, and controls the second switch 634 such that connection between the fourth terminal 628 of the interface unit 620 and the microphone signal transmission line is turned off and connection between the fourth terminal 628 of the interface unit 620 and the power supply line is turned on.

In this case, the microphone signal transmission line may be connected with a mode signal transmission line for transmitting the mode signal generated from the controller 640.

Therefore, the controller 640 of the mobile terminal 600 generates a mode signal for the current execution mode and transmits the generated mode signal to the earphone 500 through the mode signal transmission line connected to the controller 640 and the second terminal 624 of the interface unit 620.

The controller 640 of the mobile terminal 600 supplies the power source to the earphone 500 through the fourth terminal 628 of the interface unit 620.

Next, the controller of the earphone 500 identifies the mode signal of the mobile terminal 600, which is received through the second terminal 544 of the interface unit 540.

In this case, the mode signal is received through the second terminal 544 of the interface unit 540, and is applied to the controller of the earphone 500 through a decoding unit that includes a comparator 597 and a decoder 598.

At this time, the controller of the earphone 500 may be included in the noise cancellation unit 550.

The noise cancellation unit 550 may be supplied with the power source applied through the fourth terminal 548 of the interface unit 540.

Next, if the mode signal received from the mobile terminal 600 is a control mode signal, the controller of the earphone 500 turns off the first and second switches 562 and 564, and controls the third switch 566 such that connection between the second terminal 544 of the interface unit 540 and the microphone unit 510 is turned on and connection between the second terminal 544 of the interface unit 540 and the noise cancellation unit 550 is turned off.

Therefore, if the mobile terminal 600 corresponds to a control mode, the controller 640 of the mobile terminal 600 encodes a control signal through an encoding unit and applies the encoded control signal to the controller of the earphone 500 through the first switch 632, the second terminal 624 of the interface unit 620, the second terminal 544 of the interface unit 540, and a decoding unit that includes a comparator 597 and a decoder 598.

In this case, the control signal of the mobile terminal 600 may be a signal for controlling noise cancellation setup for the noise cancellation unit 550 of the earphone 500.

For example, a setup mode of the noise cancellation unit 550 may include a noise cancellation mode, an off mode, and a street mode.

The noise cancellation mode is intended to cancel external noise, and may cancel external noise at a maximum level, a middle level and a minimum level.

Also, the off mode is intended so as not to cancel external noise and turns off a function of the noise cancellation unit 550.

Subsequently, the street mode is a mode for receiving peripheral noise because there may be a risk of accident if a user of the earphone fails to listen to a peripheral vehicle sound when the user uses the earphone at the street.

Therefore, the street mode may receive external at a maximum level, a middle level and a minimum level.

FIG. 16 illustrates circuit connection between the mobile terminal and the earphone when the mobile terminal is in a bypass mode of the noise cancellation unit.

As shown in FIG. 16, if the current execution mode is a bypass mode of the noise cancellation unit and the earphone type is an earphone for noise cancellation, the controller 640 of the mobile terminal 600 controls the first switch 632 such that connection between the second terminal 624 of the interface unit 620 and the second audio signal line of the audio processor 650 is turned on and connection between the second terminal 624 of the interface unit 620 and the microphone signal transmission line is turned off, and controls the second switch 634 such that connection between the fourth terminal 628 of the interface unit 620 and the microphone signal transmission line is turned off and connection between the fourth terminal 628 of the interface unit 620 and the power supply line is turned on.

In this case, the microphone signal transmission line may be connected with a mode signal transmission line for transmitting the mode signal generated from the controller 640.

Therefore, the controller 640 of the mobile terminal 600 generates a mode signal for the current execution mode and transmits the generated mode signal to the earphone 500 through the mode signal transmission line connected to the controller 640 and the second terminal 624 of the interface unit 620.

The controller 640 of the mobile terminal 600 supplies the power source to the earphone 500 through the fourth terminal 628 of the interface unit 620.

Next, the controller of the earphone 500 identifies the mode signal of the mobile terminal 600, which is received through the second terminal 544 of the interface unit 540.

In this case, the mode signal is received through the second terminal 544 of the interface unit 540, and is applied to the controller of the earphone 500 through a decoding unit that includes a comparator 597 and a decoder 598.

At this time, the controller of the earphone 500 may be included in the noise cancellation unit 550.

The noise cancellation unit 550 may be supplied with the power source applied through the fourth terminal 548 of the interface unit 540.

Next, if the mode signal received from the mobile terminal 600 is a bypass mode signal of the noise cancellation unit, the controller of the earphone 500 turns off the first and second switches 562 and 564, and controls the third switch 566 such that connection between the second terminal 544 of the interface unit 540 and the microphone unit 510 is turned off and connection between the second terminal 544 of the interface unit 540 and the noise cancellation unit 550 is turned on.

Also, the controller of the earphone 500 turns on the fifth switch 574 connected between the noise receiving unit 590 and the noise cancellation unit 550 to transmit the noise signal received from the noise receiving unit 590 to the noise cancellation unit 550.

Therefore, if the mobile terminal 600 corresponds to a bypass mode of the noise cancellation unit, the first audio signal of the mobile terminal 600 may be transmitted to the first speaker unit 520 through L terminal of the audio processor 650, the first terminal 622 of the interface unit 620, the first terminal 542 of the interface unit 540, and the first switch 562.

The second audio signal of the mobile terminal 600 may be transmitted to the second speaker unit 530 through R terminal of the audio processor 650, the first switch 632, the second terminal 624 of the interface unit 620, the second terminal 544 of the interface unit 540, and the second switch 564.

As the case may be, the bypass mode of the noise cancellation unit of the mobile terminal 600 may not be executed when the call mode of the mobile terminal 600 is performed.

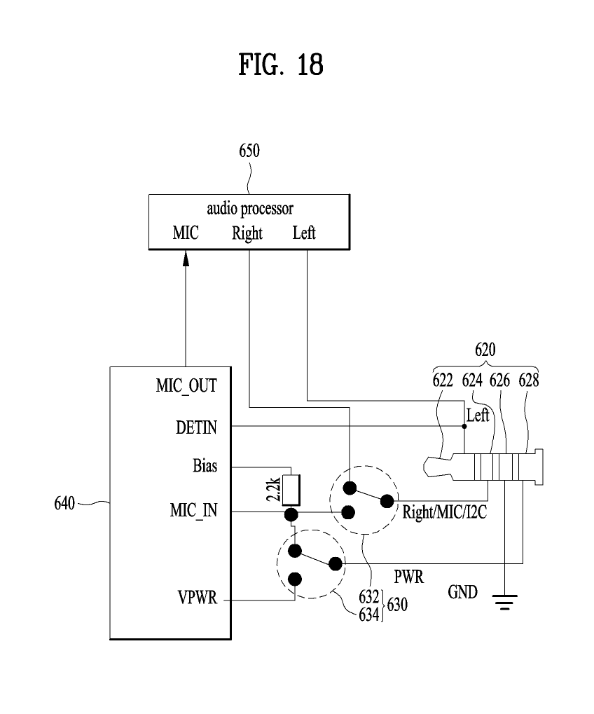

FIG. 17 is a view illustrating circuit connection between a mobile terminal and an earphone according to detachment of the earphone.

As shown in FIG. 17, the earphone 500 may include a noise receiving unit 590 and a sensing unit 595.

In this case, the sensing unit 595 may sense attachment or detachment of the earphone, and may be a proximity sensor.

For example, the second speaker unit 530 of the earphone 500 may include a noise receiving unit 590 and a sensing unit 595.

If the mode signal received from the mobile terminal is a call mode signal and the signal sensed by the sensing unit 595 is a detachment signal of the earphone 500, the controller of the earphone 500 may control the third switch 566 such that connection between the second terminal 544 of the interface unit 540 and the microphone unit 510 is turned off and connection between the second terminal 544 of the interface unit 540 and the noise cancellation unit 550 is turned on.

Also, the controller of the earphone 500 may turn on the fourth switch 572 and turn off the fifth switch 574.

Therefore, the microphone signal of the earphone 500 may be transmitted to the mobile terminal 600 through the noise receiving unit 590 instead of the microphone unit 510.

For example, if the earphone 500 provided with the second speaker unit 530 is detached from ears of the user during the call mode, the controller of the earphone 500 may control the third, fourth and fifth switches 566, 572 and 574 to turn off the function of the microphone 510 and switch the noise receiving unit to the function of the microphone unit.

Therefore, the microphone signal of the earphone 500 may be transmitted to the audio processor 650 through the noise receiving unit 595, the fourth switch 572, the second terminal 544 of the interface unit 540, the second terminal 624 of the interface unit 620, the first switch 632 and the controller 640.

If the user again attaches the earphone to his/her ears, the controller of the earphone 500 may control the third, fourth and fifth switches 566, 572 and 574 to turn on the function of the microphone 510 and again switch the noise receiving unit to the noise receiving function.

Therefore, the microphone signal of the earphone 500 may be transmitted to the audio processor 650 through the microphone unit 510, the third switch 566, the second terminal 544 of the interface unit 540, the second terminal 624 of the interface unit 620, the first switch 632 and the controller 640.

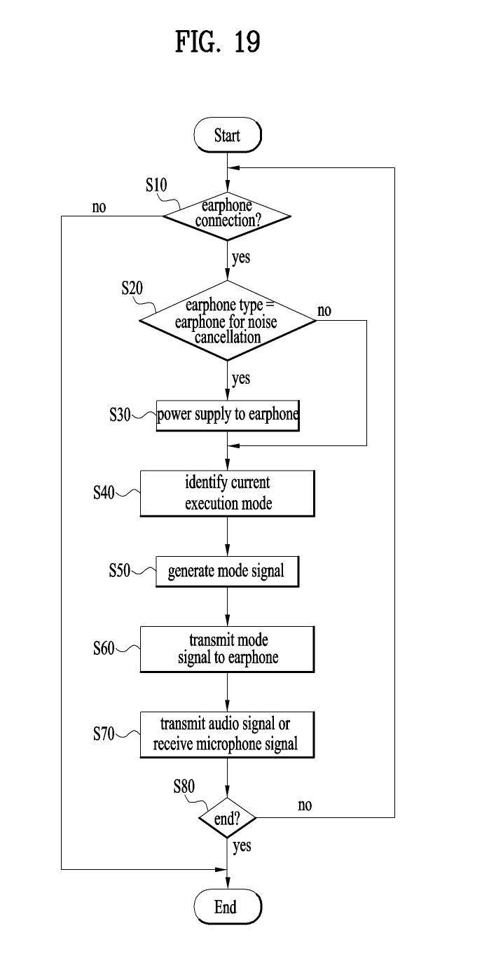

FIG. 18 is a view illustrating circuit connection of a mobile terminal according to a type of an earphone.

As shown in FIG. 18, if the interface unit 540 of the earphone 500 is connected to the interface unit 620 of the mobile terminal 600, the controller 640 of the mobile terminal 600 analyzes the current execution mode of the mobile terminal 600 and a type of the earphone 500.

In this case, the controller 640 of the mobile terminal 600 may determine the current execution mode by identifying the mode which is currently executed on the display screen when analyzing the current execution mode.

Also, the controller 640 of the mobile terminal 600 may identify the current type of the earphone in accordance with the impedance value of the earphone, which is measured by the impedance measurement unit, when analyzing the type of the earphone 500.

That is, the controller 640 of the mobile terminal 600 may measure the impedance of the earphone 500 and identify the earphone type in accordance with the measured impedance value if the earphone 500 is connected thereto.

For example, if the measured impedance value of the earphone is greater than the reference value, the controller 640 of the mobile terminal 600 may determine the earphone type as an earphone for noise cancellation and control the switching unit to supply the power source to the earphone.

If the measured impedance value of the earphone is smaller than or equal to the reference value, the controller 640 of the mobile terminal 600 may determine the earphone type as a normal earphone and control the switching unit to block power supply to the earphone.

The controller 640 of the mobile terminal 600 may measure only an impedance value for an audio terminal of the interface unit of the earphone 500 when measuring an impedance value of the earphone 500, or may measure both the first impedance value for the audio terminal and a second impedance value for the microphone terminal.

For example, the controller 640 of the mobile terminal 600 may measure a first impedance value for an audio terminal of the earphone 500 and a second impedance value for a microphone terminal if the earphone 500 is connected thereto. If the first impedance value is greater than a first reference value and the second impedance value is greater than a second reference value, the controller 640 may determine the earphone type as an earphone for noise cancellation and control the switching unit to supply the power source to the earphone.

Also, if the first impedance value is smaller than or equal to the first reference value and the second impedance value is smaller than or equal to the second reference value, the controller 640 of the mobile terminal 600 may determine the earphone type as a normal earphone and control the switching unit to block power supply to the earphone.

As shown in FIG. 18, if the earphone type is not an earphone for noise cancellation, the controller 640 of the mobile terminal 600 may control the first switch 632 such that connection between the interface unit 620 and the second audio signal line of the audio processor 650 is turned on and connection between the interface unit 620 and the microphone signal transmission line is turned off, and may control the second switch 634 such that connection between the interface unit 620 and the microphone signal transmission line is turned on and connection between the interface unit 620 and the power supply line is turned off.

Also, the controller 640 of the mobile terminal 600 may generate a mode signal for the current execution mode, control the switching unit 630 in accordance with the generated mode signal and control the interface unit 620 to transmit the generated mode signal to the mobile terminal.

In this case, the controller 640 of the mobile terminal 600 may determine power supply to the earphone in accordance with the earphone type and then generate a mode signal for the current execution mode.

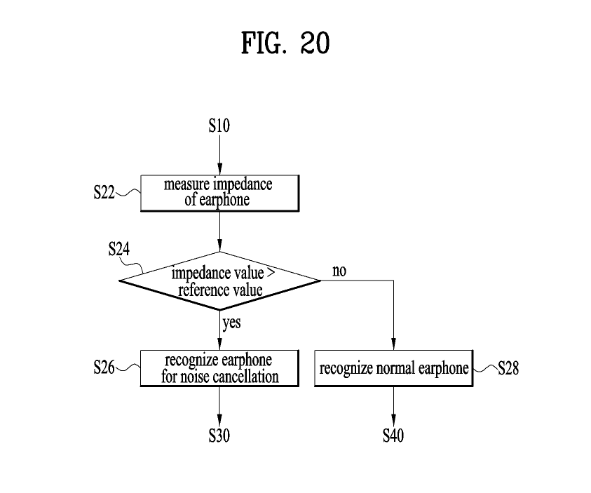

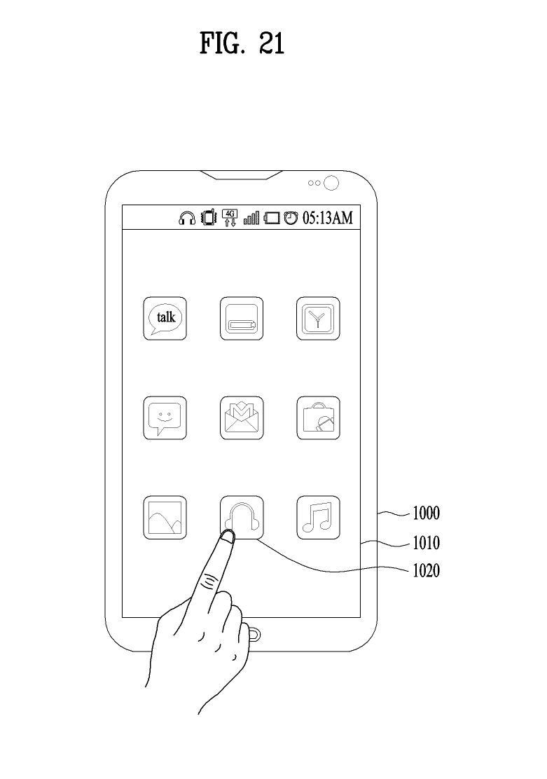

FIG. 19 is a flow chart illustrating a method for controlling a mobile terminal according to one embodiment of the present invention, and FIG. 20 is a view illustrating a method for identifying a type of an earphone.

As shown in FIGS. 19 and 20, the mobile terminal identifies connection of the earphone (S10).

The mobile terminal identifies a type of the earphone if the earphone is connected thereto (S20).

In this case, the mobile terminal measures an impedance value of the earphone when identifying the type of the earphone as shown in FIG. 20 (S22).

Subsequently, the mobile terminal identifies whether the measured impedance value of the earphone is greater than the reference value (S24).

Next, if the measured impedance value of the earphone is greater than the reference value, the mobile terminal recognizes the earphone type as an earphone for noise cancellation (S26).

If the measured impedance value of the earphone is smaller than or equal to the reference value, the mobile terminal recognizes the earphone as a normal earphone (S28).

As the case may be, the mobile terminal measures a first impedance value for an audio terminal of the interface unit of the earphone and a second impedance value for a microphone terminal when identifying the type of the earphone.

The mobile terminal identifies whether the measured first impedance value is greater than the first reference value and the second impedance value is greater than the second reference value.

Subsequently, if the measured first impedance value is greater than the first reference value and the second impedance value is greater than the second reference value, the mobile terminal recognizes the earphone type as an earphone for noise cancellation.

Also, if the measured first impedance value is smaller than or equal to the first reference value and the second impedance value is smaller than or equal to the second reference value, the mobile terminal recognizes the earphone type as a normal earphone.

Next, as shown in FIG. 19, the mobile terminal supplies the power source to the earphone if the type of the earphone is an earphone for noise cancellation.

If the type of the earphone is not the earphone for noise cancellation, the mobile terminal blocks power supply to the earphone (S30).

Subsequently, the mobile terminal identifies the current execution mode (S40), and generates a mode signal for the current execution mode (S50).

And, the mobile terminal may transmit the generated mode signal to the earphone (S60), and may transmit the audio signal to the earphone or receive the microphone signal of the earphone in accordance with the mode signal (S70).

Next, the mobile terminal identifies whether connection with the earphone ends (S80), and blocks signal transmission to the earphone if connection with the earphone ends.

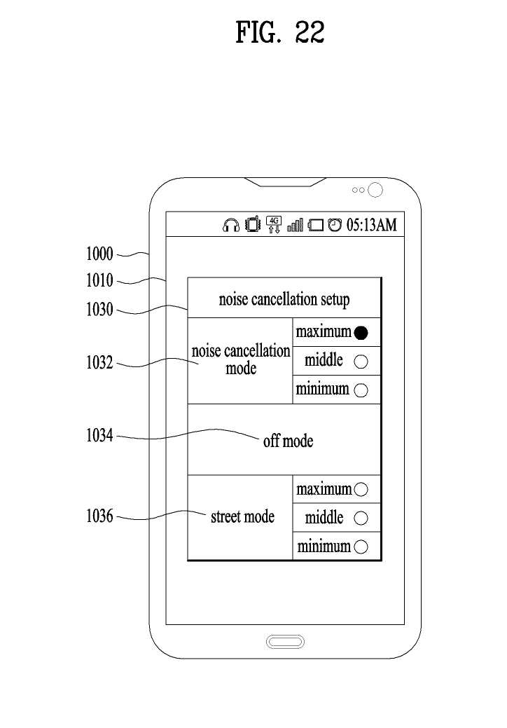

FIGS. 21 and 22 are views illustrating a method for setting a noise cancellation of an earphone.

As shown in FIGS. 21 and 22, a mobile terminal 1000 may display a noise cancellation setup icon 1020 of the earphone on a display screen 1010.

If a user input that touches the noise cancellation setup icon 1020 of the earphone is received, the mobile terminal 1000 may display a noise cancellation setup window 1030 on the display screen 1010.

In this case, the noise cancellation setup window 1030 may include a noise cancellation setup mode of the earphone.

For example, the noise cancellation setup mode may include a noise cancellation mode 1032, an off mode 1034, and a street mode 1036.

The noise cancellation mode 1032 is intended to cancel external noise, and may cancel external noise at a maximum level, a middle level and a minimum level.

Also, the off mode 1034 is intended so as not to cancel external noise and turns off a noise cancellation function of the earphone.

Subsequently, the street mode 1046 is a mode for receiving peripheral noise because there may be a risk of accident if a user of the earphone fails to listen to a peripheral vehicle sound when the user uses the earphone at the street.

Therefore, the street mode 1036 may receive external at a maximum level, a middle level and a minimum level.

As described above, according to the present invention, an earphone, which improves sound quality and has convenient portability by cancelling external noise even without a separate battery, may be provided.

Also, according to the present invention, since the mobile terminal and the earphone are capable of performing communication with each other, there may be provided convenience in that the mobile terminal may control the earphone.

Also, according to the present invention, there may be provided convenience in that a purpose of use of the microphone may be varied in accordance with attachment or detachment of the earphone.

Also, according to the present invention, since power supply to the earphone is determined in accordance with the type of the earphone, there is compatibility of various types of earphones.

It will be apparent to those skilled in the art that the present specification can be embodied in other specific forms without departing from the spirit and essential characteristics of the specification.

The above-described present invention may be implemented in a medium in which a program is recorded, as a code that can be read by a computer. Example of the medium that can be read by a computer include an HDD (hard disk drive), an SSD (solid state disk), an SDD (silicon disk drive), a ROM, a RAM, a CD-ROM, a magnetic tape, a floppy disk, and an optical data storage unit. Also, another example of the recording medium may be implemented in a type of carrier wave (for example, transmission through Internet). Also, the computer may include the controller of the mobile terminal.

Thus, the above detailed description is to be considered in all respects as illustrative and not restrictive. The scope of the present invention should be determined by reasonable interpretation of the appended claims and all changes which come within the equivalent scope of the invention are included in the scope of the invention.

### MODE FOR CARRYING OUT THE INVENTION

Various embodiments have been described in the best mode for carrying out the present invention.

### INDUSTRIAL APPLICABILITY

The present invention is used in the field related to the mobile terminal capable of being connected with the earphone.

It will be apparent to those skilled in the art that various modifications can be made without departing from the spirit and scope of the preset invention. Therefore, all changes coming within the meaning and equivalency range of the appended claims are intended to be embraced therein.

1. A portable earphone comprising:
an earphone jack;
a first microphone unit;
a first speaker unit and a second speaker unit;
a noise cancellation unit for cancelling a noise component in the periphery of the earphone; and
an interface unit for delivering a power source supplied from a mobile terminal to the noise cancellation unit,
wherein the interface unit changes its connection switch with at least any one of the first speaker unit, the second speaker unit, and the first microphone unit on the basis of a mode of the mobile terminal while the power source is being delivered to the noise cancellation unit through a microphone line of the earphone jack.

2. The earphone according to claim 1, wherein the earphone includes a first switch switched to receive an audio output signal from the mobile terminal or transmit an audio signal from the first microphone unit to the mobile terminal through a first line, which is any one of a first audio line of the earphone jack and a second audio line of the earphone jack to deliver the audio output signal from the mobile terminal to the first speaker unit and the second speaker unit.

3. The earphone according to claim 2, wherein the first switch is connected to the second audio line of the earphone jack and the first microphone unit to transmit the audio signal from the first microphone to the mobile terminal through the second audio line of the earphone jack in case of a call mode, and is connected to the second audio line of the earphone jack and the noise cancellation unit to receive the audio output signal from the mobile terminal through the first audio line and the second audio line of the earphone jack in case of a multimedia mode.

4. The earphone according to claim 3, wherein the earphone receives the audio output signal from the mobile terminal through a first line, which is any one of the first audio line and the second audio line, and another second line in a mono type in case of the call mode, and receives the audio output signal from the mobile terminal through the first line and the second line in a stereo type in case of the multimedia mode.

5. The earphone according to claim 4, wherein the earphone transmits the audio output signal received from the mobile terminal in a mono type through the second line to the first speaker unit and the second speaker unit in case of the call mode.

6. The earphone according to claim 1, wherein the earphone jack is a four-pole plug that includes a first terminal for receiving a first audio signal from the mobile terminal, a second terminal for receiving a second audio signal from the mobile terminal, a third terminal which is grounded, and a fourth terminal for receiving the power source from the mobile terminal.

7. The earphone according to claim 1, further comprising s a sensing unit for sensing attachment or detachment of the earphone, and a second microphone unit, wherein at least any one of the first microphone unit and the second microphone unit performs an active noise cancellation (ANC) function for receiving noise in the periphery of the earphone in case of a call mode, and if any one earphone is attached to or detached from the mobile terminal during a call, the first microphone unit of the earphone which is attached or detached is used as a microphone for a call, and the second microphone unit is used as a microphone for ANC.

8. The earphone according to claim 1, wherein the earphone includes a decoding unit that performs decoding by receiving a control signal from the mobile terminal through a first line, which is any one of the first audio line and the second audio line of the earphone jack, in case of a control mode.

9. The earphone according to claim 8, wherein, if a connection switch of at least any one of the first speaker unit and the second speaker unit and the interface unit corresponds to a bypass connection of the noise cancellation unit, the earphone changes the connection switch so that the noise cancellation unit may not be bypassed, when the control signal from the mobile terminal is received.

10. The earphone according to claim 9, wherein the earphone re-changes the connection switch so that the noise cancellation unit may be bypassed, after the control signal from the mobile terminal is received.

11. The earphone according to claim 1, wherein the earphone changes the connection switch of at least any one of the first speaker unit and the second speaker unit and the interface unit to output the audio output signal from the mobile terminal to the first speaker unit and the second speaker unit through the first audio line and the second audio line of the earphone jack in case of a bypass mode of the noise cancellation unit.

12. A mobile terminal capable of being connected with an earphone, the mobile terminal comprising:
an audio processor;
an earphone socket;
an earphone sensor for sensing a type of the earphone connected to the earphone socket; and
an interface unit for delivering a power source to the earphone in accordance with the type of the earphone,
wherein the interface unit changes its connection switch with at least any one of the audio processor and the earphone sensor on the basis of an execution mode while the power source is being delivered to the earphone through a microphone line of the earphone socket.

13. The mobile terminal according to claim 12, wherein the mobile terminal includes a first switch switched to receive a microphone signal from the earphone or transmit an audio signal from the audio processor to the earphone through at least one of a first audio line and a second audio line of the earphone socket to deliver the microphone signal from the earphone to the audio processor.

14. The mobile terminal according to claim 13, wherein the first switch is connected to the second audio line of the earphone socket and the earphone sensor to transmit a microphone output signal from the earphone through the second audio line of the earphone socket in case of a call mode, and is connected to the second audio line of the earphone jack and the audio processor to transmit the audio signal from the audio processor to the earphone through the first audio line and the second audio line of the earphone socket in case of a multimedia mode.

15. The mobile terminal according to claim 14, wherein the mobile terminal transmits the audio signal from the audio processor through any one of the first audio line and the second audio line in a mono type in case of the call mode, and transmits the audio signal from the audio processor through the first audio line and the second audio line in a stereo type in case of the multimedia mode.

16. The mobile terminal according to claim 12, wherein the mobile terminal includes a second switch switched to supply the power source to the earphone through a microphone line of the earphone socket or receive a microphone output signal from the earphone through the microphone line of the earphone socket to deliver the power source to the earphone in accordance with the type of the earphone.

17. The mobile terminal according to claim 12, wherein the earphone socket is a four-pole socket that includes a first terminal for transmitting a first audio signal to the earphone, a second terminal for transmitting a second audio signal to the earphone, a third terminal which is grounded, and a fourth terminal for transmitting the power source to the earphone.

18. The mobile terminal according to claim 12, wherein the mobile terminal includes an encoding unit that encodes a control signal from the mobile terminal to transmit the control signal to the earphone through a first line, which is any one of the first audio line and the second audio line of the earphone socket, in case of a control mode of the earphone.

19. The mobile terminal according to claim 12, wherein the earphone sensor measures an impedance value of the earphone if the earphone is connected thereto, and identifies the type of the earphone in accordance with the measured impedance value.

20. The mobile terminal according to claim 19, wherein the earphone sensor determines the type of the earphone as an earphone for power supply if the measured impedance value of the earphone is greater than a reference value, and changes the connection switch of the interface unit to supply the power source to the earphone.
